(19) United States
(12) Patent Application Publication
(10) Pub. No.: US 2024/0414599 A1
(43) Pub. Date: Dec. 12, 2024

(54) ACCESS CONTROL (ACL) FOR INDIRECT DATA FORWARDING DURING S1 AND NG BASED HANDOVER

(71) Applicant: Telefonaktiebolaget LM Ericsson (publ), Stockholm (SE)

(72) Inventors: Qian CHEN, MÖLNDAL (SE); Stefan ROMMER, Västra Frölunda (SE); Angelo CENTONZA, GRANADA (ES); Yunjie LU, SHANGHAI (CN); Shabnam SULTANA, MONTREAL Quebec (CA); Yong YANG, KÅLLERED (SE)

(73) Assignee: Telefonaktiebolaget LM Ericsson (publ), Stockholm (SE)

(21) Appl. No.: 18/699,239

(22) PCT Filed: Oct. 7, 2022
(86) PCT No.: PCT/EP2022/077944

§ 371 Date: Apr. 5, 2024

Related U.S. Application Data
(60) Provisional application No. 63/256,160, filed on Oct. 15, 2021.

(30) Foreign Application Priority Data
Oct. 8, 2021 (WO) PCT/CN2021/122636

(51) Int. Cl. H04W 36/00; H04W 36/36

(52) U.S. Cl. CPC H04W 36/0016; H04W 36/0055; H04W 36/362

(57) ABSTRACT

A method (500) performed by a first network function. The method includes receiving a handover related message related to a handover of UE from a source RAN node to a target RAN node. The method also includes after receiving the handover related message, transmitting to a second network function a request message for establishing a forwarding tunnel. The method also includes receiving a response message transmitted by the second network function, wherein the response message is responsive to the request message for establishing a forwarding tunnel, and further wherein the response message comprises an address that the second network function will use as a source address when forwarding packets for the UE via the established forwarding tunnel to the target RAN node. The method also includes after receiving the response message, transmitting a message comprising the source address, wherein the message is transmitted to: i) the target RAN node or ii) a third network function that is configured to transmit the source address to the target RAN node.

### TECHNICAL FIELD

Disclosed are embodiments related to access control.

### BACKGROUND

Access control functionality (a.k.a., “Access Control List (ACL)” functionality) is supported for data handling between a source radio access network (RAN) node and target RAN node for the X2 and Xn communications. The source RAN node provides ACL information to the target RAN node. The target RAN node then uses the ACL information to control the incoming traffic originating from the source RAN node during an X2 or Xn handover. The ACL functionality is defined in 3rd Generation Partnership Project (3GPP) Technical Specification (TS) 36.413 V16.6.0 (“TS 36.413”). As stated in TS 36.413, “ACL Functionality” is “a functionality controlling the access to network nodes. In case of Access Control Lists (ACL) functionality is applied in a network node the network node may only accept connections from other peer network nodes once the source addresses of the sending network node is already known in the target node.”

In current 3GPP technical specifications, the source RAN addresses are transferred to the target RAN at the time of X2/Xn address discovery. Namely, the user plane (UP) addresses that a source RAN may use are signalled to a target RAN via the core network (CN), as part of e.g., the Next Generation Application Protocol (NGAP) Mobility Management Entity (MME) Configuration Transfer message. As stated in TS 36.413, “If the eNodeB receives, in the [Self Organizing Network (SON)] Configuration Transfer [Information Element (IE)], the X2 [Transport Network Layer (TNL)] Configuration Info IE containing the eNodeB X2 Extended Transport Layer Addresses IE, it may use it as part of its ACL functionality configuration actions, if such ACL functionality is deployed.”

Further use cases have been highlighted, which need standardization changes in order to support ACL. One of them is indirect data forwarding. As stated in 3GPP Technical Document (Tdoc) no. R3-213889, “in the case of [S1-based handover (HO) and NG-based HO], data forwarding from HO source to HO target is possible. However, the HO source address is not known to the HO target node. One solution is to add the source IP address for bearers subject to data forwarding in the HO signalling (from source to target). Such addition can be done in two possible ways: (1) to tackle direct data forwarding, i.e. data forwarding where the traffic source towards the target RAN is the source RAN; in this case the source IP address should be added to the Source To Target Transparent Container IE signalled by the HO source to the HO target node; or (2) to tackle indirect data forwarding, i.e. data forwarding where the traffic source towards the target RAN node is the CN; in this case the source IP address should be added to the S1/NG: HO Request message.”

It has been agreed that ACL control can be applied for indirect data forwarding during S1 and NG based handover. 3GPP Tdoc no. R3-214414 proposed to include ACL information (the indirect data forwarding tunnel information from the CN side) in the Handover Request message.

### Existing HO Procedure Descriptions

The existing S1-based handover, normal procedure is described in 3GPP TS 23.401 V17.2.0 (“TS 23.401”). FIG. 1 illustrates the procedure. The steps shown in FIG. 1 are described in TS 23.401.

The existing preparation phase for inter Next Generation (NG) RAN (NG-RAN) node N2 based handover is described in 3GPP TS 23.502 V17.2.0 (“TS 23.502”). FIG. 2 illustrates the procedure. The steps shown in FIG. 2 are described in TS 23.502 at section 4.9.1.3.2.

### SUMMARY

Certain challenges presently exist. For example, according to the current flow for S1 handover and NG handover defined in TS 23.401 and 23.502, respectively, it's not possible for the respective core network function (e.g., MME, Session Management Function (SMF) to include in the Handover Request that is sent to the target RAN node the source address—i.e., the address that a network function will use as a source address when forwarding to the target RAN node via a forwarding tunnel packets for the UE. Thus, to support ACL in indirect data forwarding cases a solution is required.

Additional challenges also exist. Due to the GTP-U source address not being significant in the processing of a received GTP-U packet, the receiver is not aware of what source IP address a GTP-U sender will use. The GTP-U receiver is assumed to accept the GTP-U packet from any source IP address. However, for ACLs to work, the receiver needs to be aware of what valid source IP address(es) is/are used, so that the receiver can discard packets that arrive from invalid source addresses.

In existing systems, the source IP address of GTP-U packets is not negotiated between tunnel endpoints. Overall signaling for introducing such source IP address negotiation/notification has been proposed. However, a specific problem that has not been solved is how the GTP-U source IP address(es) in a User Plane Function (UPF) are provided to a Session Management Function (SMF), so that SMF can forward it/them to RAN. The same applies between a Serving Gateway (SGW) Control plane function (SGW-C) and an SGW User plane function (SGW-U) and between a Packet Gateway (PGW) Control plane function (PGW-C) and a PGW User plane function (PGW-U). The existing protocol between a Control Plane (CP) (e.g., an SMF), and a User Plane (e.g., a UPF) does not provide the GTP-U source addresses.

Accordingly, in one aspect there is provided a method performed by a first network function (e.g., MME, Access and Mobility Management Function (AMF), SMF). In one embodiment, the method includes receiving a handover related message related to a handover of a UE from a source RAN node to a target RAN node. The method also includes, after receiving the handover related message, transmitting to a second network function a request message for establishing a forwarding tunnel. The method also includes receiving a response message transmitted by the second network function, wherein the response message is responsive to the request message for establishing a forwarding tunnel, and further wherein the response message comprises an address that the second network function will use as a source address when forwarding packets for the UE via the established forwarding tunnel to the target RAN node. The method further includes, after receiving the response message, transmitting a message comprising the source address, wherein the message is transmitted to: i) the target RAN node or ii) a third network function that is configured to transmit the source address to the target RAN node.

In another embodiment the method includes receiving a handover related message related to a handover of a UE from a source RAN node to a target RAN node. The method also includes, after receiving the handover related message, transmitting to a second network function a request message. The method also includes receiving a response message transmitted by the second network function, wherein the response message is responsive to the request message, and further wherein the response message comprises an address that a third network function (e.g., User Plane Function (UPF)) will use as a source address when forwarding packets for the UE via a forwarding tunnel to the target RAN node. The method further includes, after receiving the response message, transmitting to the target RAN node a message comprising the source address.

In another aspect there is provided a method performed by a control plane function. The method includes requesting one or more General Packet Radio System, GPRS, Tunneling Protocol User Plane, GTP-U, source Internet Protocol, IP, addresses that are used by a user plane function to send one or more GTP-U packets to a peer GTP-U entity for unicast communication. The method also includes receiving one or more GTP-U source IP addresses that are used by the user plane function to send one or more GTP-U packets to the peer GTP-U entity for unicast communication. In another aspect there is provided a method performed by a control plane function. The method includes receiving one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by a user plane function. The method also includes providing the received one or more GTP-U source IP addresses of the remote peer GTP-U entity to the user plane function. In another aspect there is provided a method performed by a user plane function. The method includes receiving a request for one or more General Packet Radio System, GPRS, Tunneling Protocol User Plane, GTP-U, source Internet Protocol, IP, addresses that are used by the user plane function to send one or more GTP-U packets to a peer GTP-E entity for unicast communication, wherein the request is sent by a control plane function. The method also includes sending one or more GTP-U source IP addresses that are used by the user plane function to send one or more GTP-U packets to the peer GTP-U entity for unicast communication.

In another aspect there is provided a method performed by a user plane function, The method includes receiving one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by the user plane function. The method also includes receiving a GTP-U packet. The method also includes verifying that a GTP-U source IP address of the received GTP-U packet matches a GTP-U source IP address of the received one or more GTP-U source IP addresses of the remote peer GTP-U entity.

In another aspect there is provided a method performed by a user plane function. The method includes sending to a Network Repository Function (NRF) one or more General Packet Radio System, GPRS, Tunneling Protocol User Plane, GTP-U, source Internet Protocol, IP, addresses that are used by the user plane function to send one or more GTP-U packets.

In another aspect there is provided a computer program comprising instructions which when executed by processing circuitry of a network node causes the network node to perform any of the methods disclosed herein. In one embodiment, there is provided a carrier containing the computer program wherein the carrier is one of an electronic signal, an optical signal, a radio signal, and a computer readable storage medium.

In another aspect there is provided a network node that is configured to perform the methods disclosed herein. In some embodiments, the network node comprises a data storage system and processing circuitry coupled to the data storage system, wherein the network node is configured to perform the methods disclosed herein.

An advantage of at least some of the embodiments disclosed herein is that they provide ACL control without impacting the S1 and N2 handover procedure thereby eliminating a potential security issue in the S1 and N2 handover procedure. Other embodiments provide the advantage of enabling ACLs to be enforced in RAN (e.g., based on what valid GTP-U source IP addresses are used by the user plane (e.g., UPF) as well as additionally or alternatively providing the advantage of enabling ACLs to be enforced in the user plane (e.g., UPF) based on what valid GTP-U source IP addressed are used by RAN or other user planes (e.g., UPFs).

### BRIEF DESCRIPTION OF THE DRAWINGS

The accompanying drawings, which are incorporated herein and form part of the specification, illustrate various embodiments.

FIG. 1 is a message flow diagram illustrating first conventional handover process.

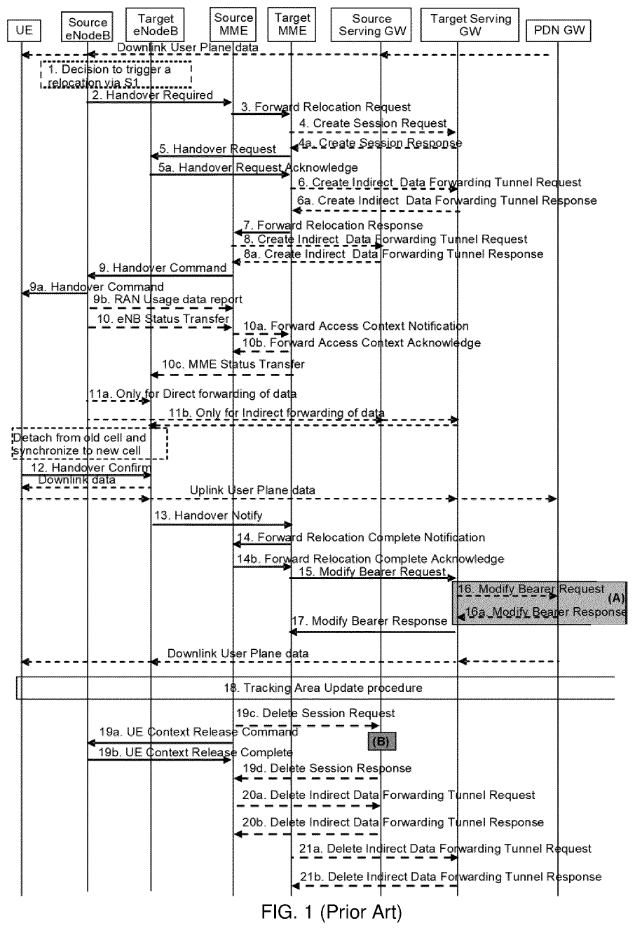

FIG. 2 is a message flow diagram illustrating second conventional handover process.

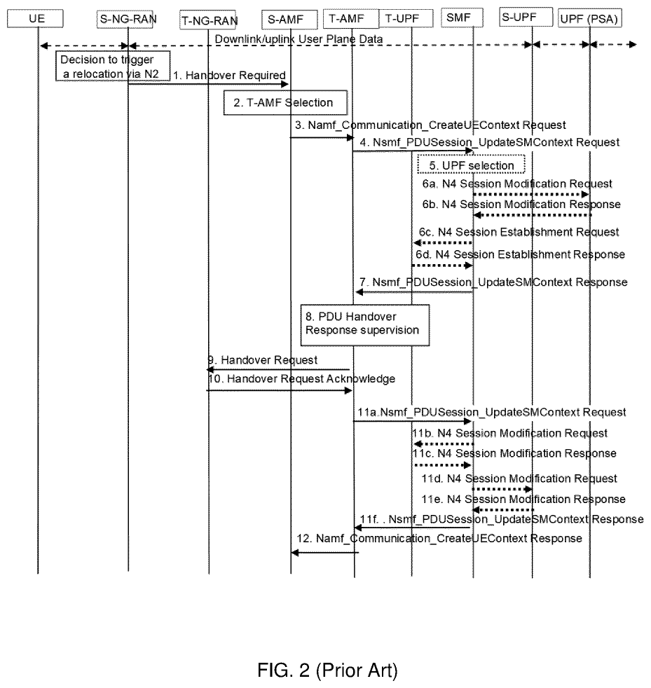

FIG. 3 is a message flow diagram illustrating a handover process according to some embodiments.

FIG. 4 is a message flow diagram illustrating a handover process according to some embodiments.

FIG. 5 is a flowchart illustrating a process according to some embodiments.

FIG. 6 is a flowchart illustrating a process according to some embodiments.

FIG. 7 is a message flow diagram illustrating a per-session source IP address handling process according to some aspects.

FIG. 8 is a message flow diagram illustrating a per-node source IP address handling process according to some aspects.

FIG. 9 is a flowchart illustrating a process according to some embodiments.

FIG. 10 is a flowchart illustrating a process according to some embodiments.

FIG. 11 is a flowchart illustrating a process according to some embodiments.

FIG. 12 is a flowchart illustrating a process according to some embodiments.

FIG. 13 is a flowchart illustrating a process according to some embodiments.

FIG. 14 is a block diagram of a network node according to some embodiments.

### DETAILED DESCRIPTION

As noted above, a solution is needed to support ACL functionality in indirect data forwarding cases. This disclosure, therefore, provides methods for a RAN node to receive information enabling ACL support in case of indirect data forwarding.

In one embodiment, a network function (e.g., the Long Term Evolution (LTE) (or 4G) Mobility Management Entity (MME) or the 5G Access and Mobility Management Function (AMF)) communicates with another network function (e.g. the 4G Serving Gateway (SGW) or the 5G Session Management Function (SMF)) before the Handover Request is transmitted towards the target RAN node to obtain the needed source address include the source address in the Handover Request transmitted to the RAN node. This and other embodiments are described below.

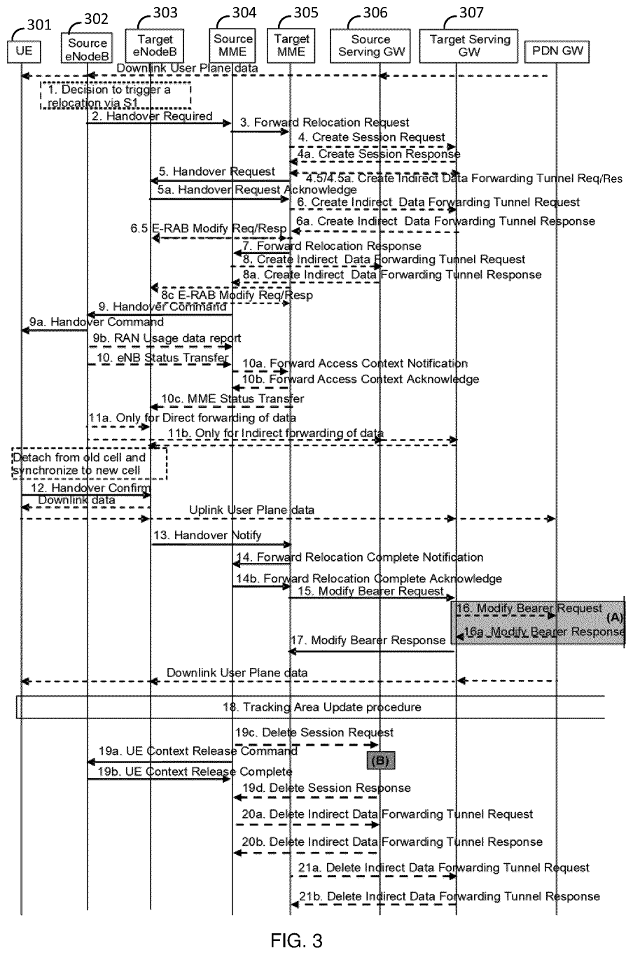

FIG. 3 is a message flow diagram illustrating an S1 handover according to some embodiments. Steps shown in FIG. 3 are described below. In the description below, if the SGW is not relocated, the box “Source Serving GW” in FIG. 3 is acting as the target Serving GW.

1. A source eNodeB 302 decides to initiate an S1-based handover for a UE 101 to the target eNodeB 303. This can be triggered by, for example, no X2 connectivity to the target eNodeB, or by an error indication from the target eNodeB after an unsuccessful X2-based handover, or by dynamic information learnt by the source eNodeB.

2. The source eNodeB sends Handover Required (Direct Forwarding Path Availability, Source to Target transparent container, target eNodeB identity (ID), Closed Subscriber Group (CSG) ID, CSG access mode, target Tracking Area Identity (TAI), S1AP Cause) to the source MME 304. The source eNodeB indicates which bearers are subject to data forwarding. Direct Forwarding Path Availability indicates whether direct forwarding is available from the source eNodeB to the target eNodeB. This indication from source eNodeB can be based on e.g. the presence of X2. The target TAI is sent to MME to facilitate the selection of a suitable target MME 305. When the target cell is a CSG cell or a hybrid cell, the source eNodeB shall include the CSG ID of the target cell. If the target cell is a hybrid cell, the CSG access mode shall be indicated.

3. The source MME selects the target MME as described in clause 4.3.8.3 on “MME Selection Function” and if it has determined to relocate the MME, it sends a Forward Relocation Request (MME UE context, Source to Target transparent container, RAN Cause, target eNodeB Identity, CSG ID, CSG Membership Indication, target TAI, MS Info Change Reporting Action (if available), CSG Information Reporting Action (if available), UE Time Zone, Direct Forwarding Flag, Serving Network, Local Home Network ID, LTE-M UE Indication) message to the target MME. The target TAI is sent to the target MME to help it to determine whether Serving Gateway (SGW) relocation is needed (and, if needed, aid SGW selection). The old Serving Network is sent to target MME to support the target MME to resolve if Serving Network is changed. In network sharing scenarios Serving Network denotes the serving core network.

The source MME shall perform access control by checking the UE's CSG subscription when CSG ID is provided by the source eNodeB. If there is no subscription data for this CSG ID or the CSG subscription is expired, and the target cell is a CSG cell, the source MME shall reject the handover with an appropriate cause unless the UE has emergency bearer services.

The MME UE context includes International Mobile Subscriber Identity (IMSI), Mobile Equipment (ME) Identity, UE security context, UE Network Capability, aggregate maximum bit rate (AMBR), Selected CN operator ID, APN restriction, Serving GW address and Tunnel Endpoint Identifier (TEID) for control signalling, and Evolved Packet System (EPS) Bearer context(s), UE Radio Capability ID.

An EPS Bearer context includes the Packet Data Network (PDN) GW addresses and TEIDs (for General Packet Radio Service (GPRS) Tunnel Protocol (GTP) based S5/S8) or Generic Routing Encapsulation (GRE) keys (for Proxy Mobile IP (PMIP) based S5/S8) at the PDN GW(s) for uplink traffic, Access Point Name (APN), Serving GW addresses and TEIDs for uplink traffic, and Tl.

Based on the Cellular Internet-of-Things (CIoT) Evolved Packet System (EPS) Optimization capabilities of the target MME (determined according to the target MME selection procedure of clause 4.3.8.3) the source MME only includes the EPS Bearer Context(s) that the target MME can support. If none of the UE's EPS Bearers can be supported by the selected target MME, the source MME rejects the S1 handover attempt by sending a Handover Preparation Failure (Cause) message to the Source eNodeB. If the target MME supports CIoT EPS Optimization and the use of header compression has been negotiated between the UE and the source MME, the source MME also includes in the Forward Relocation Request the previously negotiated Header Compression Configuration that includes the information necessary for the Robust Header Compression (RoHC) channel setup but not the RoHC context itself.

If the source MME includes EPS Bearer Context, in addition to the Serving GW IP address and TEID for S1-U use plane, the source MME also includes Serving GW IP address and TEID for S11-U, if available.

NOTE 3: If the handover is successful, the source MME will signal to the SGW and/or SCEF to release any non-included EPS Bearers after step 14. The non-included bearers are locally released by the UE following the Bearer Context Status synchronisation that occurs during the Tracking Area Update at step 18.

If selective IP traffic offload (SIPTO) at the Local Network is active for a PDN connection in the architecture with stand-alone GW the source MME shall include the Local Home Network ID of the source cell in the EPS Bearer context corresponding to the SIPTO at the Local Network PDN connection.

RAN Cause indicates the S1AP Cause as received from source eNodeB.

The source MME includes the CSG ID in the Forward Relocation Request when the target cell is a CSG or hybrid cell. When the target cell is a hybrid cell, or if there are one or several emergency bearers and the target cell is a CSG cell, the CSG Membership Indication indicating whether the UE is a CSG member shall be included in the Forward Relocation Request message.

The Direct Forwarding Flag indicates if direct forwarding is applied, or if indirect forwarding is going to be set up by the source side.

The target MME shall determine the Maximum APN restriction based on the APN Restriction of each bearer context in the Forward Relocation Request, and shall subsequently store the new Maximum APN restriction value.

If the UE receives only emergency services and the UE does not have a Universal Integrated Circuit Card (UICC) (i.e., the UE is UICCless), IMSI cannot be included in the MME UE context in Forward Relocation Request message. For emergency attached UEs, if the IMSI cannot be authenticated, then the IMSI shall be marked as unauthenticated. Also, in this case, security parameters are included only if available.

If a UE is Restricted Local Operator Service (RLOS) attached, the old MME includes an RLOS indication to the new MME. If the RLOS attached UE in the old MME does not have a Universal Subscriber Identity Module (USIM), IMSI can not be included in the Forward Relocation Request message. If the RLOS attached UE has USIM but the IMSI cannot be successfully authenticated, then the IMSI shall be marked as unauthenticated. Also, in this case, security parameters are included only if available.

If the Old MME is aware the UE is a LTE-M UE, it provides the LTE-M UE Indication to the new MME.

4. If the MME has been relocated, the target MME verifies whether the source Serving GW 306 can continue to serve the UE. If not, it selects a new Serving GW 307 (referred to as the “Target Serving Gateway”) as described in clause 4.3.8.2 on “Serving GW Selection Function”. If the MME has not been relocated, the source MME decides on this Serving GW re-selection.

If the source Serving GW 306 continues to serve the UE, no message is sent in this step. In this case, the target Serving 307 GW is identical to the source Serving GW.

If a new Serving GW is selected, the target MME sends a Create Session Request (bearer context(s) with PDN GW addresses and TEIDs (for GTP-based S5/S8) or GRE keys (for PMIP-based S5/S8) at the PDN GW(s) for uplink traffic, Serving Network, UE Time Zone) message per PDN connection to the target Serving GW. The target Serving GW allocates the S GW addresses and TEIDs for the uplink traffic on S1_U reference point (one TEID per bearer). The target Serving GW sends a Create Session Response (Serving GW addresses and uplink TEID(s) for user plane) message back to the target MME.

4.5. In one embodiment, if indirect data forwarding with ACL applies, the target MME sets up forwarding parameters by sending a Create Indirect Data Forwarding Tunnel Request (including Bearer IDs for the affected bearers) to the Serving GW. The MME also indicates that source address from Serving GW for forwarding tunnel between Serving GW and target eNodeB is needed. The Serving GW sends to the target MME a Create Indirect Data Forwarding Tunnel Response that includes Serving GW addresses and TEIDs for forwarding, as well as the address that the Serving GW will use as the source address when the Serving GW forwards packets for the UE via the established forwarding tunnel to the RAN node (the source address that the Serving GW will use for the downlink packet delivery).

Indirect forwarding may be performed via a Serving GW which is different from the Serving GW used as the anchor point for the UE.

In case the SGW is separated into SGW-C and SGW-U (i.e., control plane user plane separation (CUPS)), the SGW-C requests the SGW-U to allocate target Serving GW addresses and TEIDs for forwarding, including the source address that target Serving GW will use for the downlink packet delivery.

5. The Target MME sends to the target eNodeB a Handover Request that includes: EPS Bearers to Setup, AMBR, S1AP Cause, Source to Target transparent container, CSG ID, CSG Membership Indication, Handover Restriction List, UE Radio Capability ID, the source address that the Serving GW will use for the downlink packet delivery. This message creates the UE context in the target eNodeB, including information about the bearers, and the security context. For each EPS Bearer, the Bearers to Setup includes Serving GW address and uplink TEID for user plane, and EPS Bearer QoS. If the direct forwarding flag indicates unavailability of direct forwarding and the target MME knows that there is no indirect data forwarding connectivity between source and target, the Bearers to Setup shall include “Data forwarding not possible” indication for each EPS bearer. Handover Restriction List is sent if available in the Target MME; it is described in clause 4.3.5.7 “Mobility Restrictions”.

S1AP Cause indicates the RAN Cause as received from source MME.

The Target MME shall include the CSG ID and CSG Membership Indication when provided by the source MME in the Forward Relocation Request message.

The target eNodeB sends a Handover Request Acknowledge (EPS Bearer Setup list, EPS Bearers failed to setup list Target to Source transparent container) message to the target MME. The EPS Bearer Setup list includes a list of addresses and TEIDs allocated at the target eNodeB for downlink traffic on S1 U reference point (one TEID per bearer) and addresses and TEIDs for receiving forwarded data if necessary. If the UE AMBR is changed, e.g. all the EPS bearers which are associated to the same APN are rejected in the target eNodeB, the MME shall recalculate the new UE-AMBR and signal the modified UE AMBR value to the target eNodeB.

If none of the default EPS bearers have been accepted by the target eNodeB, the target MME shall reject the handover as specified in clause 5.5.1.2.3.

If the target cell is a CSG cell, the target eNodeB shall verify the CSG ID provided by the target MME, and reject the handover with an appropriate cause if it does not match the CSG ID for the target cell. If the target eNodeB is in hybrid mode, it may use the CSG Membership Indication to perform differentiated treatment for CSG and non-CSG members. If the target cell is a CSG cell, and if the CSG Membership Indication is “non member”, the target eNodeB only accepts the emergency bearers.

If the MME supports radio access capability signaling (RACS) as defined in clause 5.11.3a and has UE Radio Capability ID stored in the UE's context it includes it in the Handover Request message, if target eNodeB supports RACS.

If the Handover Request includes the source address that target Serving GW will use for the downlink packet delivery, then target eNodeB may use the source address for ACL as specified in 3GPP TS 36.413. For example, when the target eNodeB receives a packet, the eNodeB determines source address included in packet, and checks whether source address is included in an “allowed” list. If the source address not included in the allowed list, then the eNodeB may, in some scenarios, drop the packet.

6. If indirect forwarding applies and the Serving GW is relocated and step 4.5 is not performed, the target MME sets up forwarding parameters by sending Create Indirect Data Forwarding Tunnel Request (target eNodeB addresses and TEIDs for forwarding) to the Serving GW. The Serving GW sends a Create Indirect Data Forwarding Tunnel Response (target Serving GW addresses and TEIDs for forwarding) to the target MME. If the Serving GW is not relocated, indirect forwarding may be set up in step 8 below.

Indirect forwarding may be performed via a Serving GW which is different from the Serving GW used as the anchor point for the UE.

If step 4.5 is performed already, the target MME sends Update Indirect Data Forwarding Tunnel Request to Serving GW. The Serving GW sends a Update Indirect Forwarding Tunnel Response to the target MME.

To support step 6.5, the MME also indicates that source address from target Serving GW for forwarding tunnel between target Serving GW and target eNodeB is needed in the Create Indirect Data Forwarding Tunnel Request message. The Serving GW provides the Serving GW addresses and TEIDs for forwarding, including the source address that target Serving GW will use for the downlink packet delivery.

In case the SGW is separated into SGW-C and SGW-U (CUPS), the SGW-C requests the SGW-U to allocate target Serving GW addresses and TEIDs for forwarding, including the source address that target Serving GW will use for the downlink packet delivery.

6.5. To support the indirect data forwarding with ACL, the MME sends the S1AP E-RAB Modify Request (source address) to target eNodeB. Target sends E-RAN Modify Response to MME. The S1 message above is just an example. It can be a new message or other existing message.

If the source address that target Serving GW will use for the downlink packet delivery is included, target eNodeB may use the source address, that target Serving GW will use for the downlink packet delivery, for ACL as specified in TS 36.413.

If there is no MME and SGW change, step 6-7 are skipped, this 6.5 step will be performed as step 8c (exactly the same as this step 6.5) from source MME.

7. If the MME has been relocated, the target MME sends a Forward Relocation Response (Cause, Target to Source transparent container, Serving GW change indication, EPS Bearer Setup List, Addresses and TEIDs) message to the source MME. For indirect forwarding, this message includes Serving GW Address and TEIDs for indirect forwarding (source or target). Serving GW change indication indicates a new Serving GW has been selected.

8. If indirect forwarding applies, the source MME sends Create Indirect Data Forwarding Tunnel Request (addresses and TEIDs for forwarding) to the Serving GW. If the Serving GW is relocated it includes the tunnel identifier to the target serving GW.

The Serving GW responds with a Create Indirect Data Forwarding Tunnel Response (Serving GW addresses and TEIDs for forwarding) message to the source MME.

Indirect forwarding may be performed via a Serving GW which is different from the Serving GW used as the anchor point for the UE.

If step 4.5 is performed already, the target MME sends Update Indirect Data Forwarding Tunnel Request (target eNodeB addresses and TEIFs for forwarding) to Serving GW. The Serving GW sends a Update Indirect Forwarding Tunnel Response to the target MME.

To support the alternative in step 8.c (it's only applicable if there is no MME change), the MME also indicates that source address from Source Serving GW for forwarding tunnel between Source Serving GW and target eNodeB is needed in the Create Indirect Data Forwarding Tunnel Request message. The Source Serving GW provides the Source Serving GW addresses and TEIDs for forwarding, including the source address that Source Serving GW will use for the downlink packet delivery. In case the SGW is separated into SGW-C and SGW-U (CUPS), the SGW-C requests the SGW-U to allocate target Serving GW addresses and TEIDs for forwarding, including the source address that target Serving GW will use for the downlink packet delivery.

8c. To support the indirect data forwarding with ACL, the MME sends to target eNodeB an S1AP E-RAB Modify Request that includes the address that the Serving GW function will use as the source address when forwarding to the target RAN node via the established forwarding tunnel packets for the UE. Target eNodeB sends E-RAB Modify Response to MME. The S1 message above is just an example. It can be a new message or other existing message.

If indirect data forwarding addresses and TEIDs info includes the source address that source Serving GW will use for the downlink packet delivery, target eNodeB may use the source address that source Serving GW will use for the downlink packet delivery, for ACL as specified in TS 36.413.

9. The source MME sends a Handover Command (Target to Source transparent container, Bearers subject to forwarding, Bearers to Release) message to the source eNodeB. The Bearers subject to forwarding includes list of addresses and TEIDs allocated for forwarding. The Bearers to Release includes the list of bearers to be released.

9a. The Handover Command is constructed using the Target to Source transparent container and is sent to the UE. Upon reception of this message the UE will remove any EPS bearers for which it did not receive the corresponding EPS radio bearers in the target cell.

9b. If the Public Land Mobile Network (PLMN) has configured Secondary RAT usage data reporting and the source eNodeB has Secondary RAT usage data to report, the eNodeB sends a RAN Usage data Report (Secondary RAT usage data, handover flag) message to the source MME. The handover flag indicates to the MME that it should buffer the report before forwarding the Secondary RAT usage data.

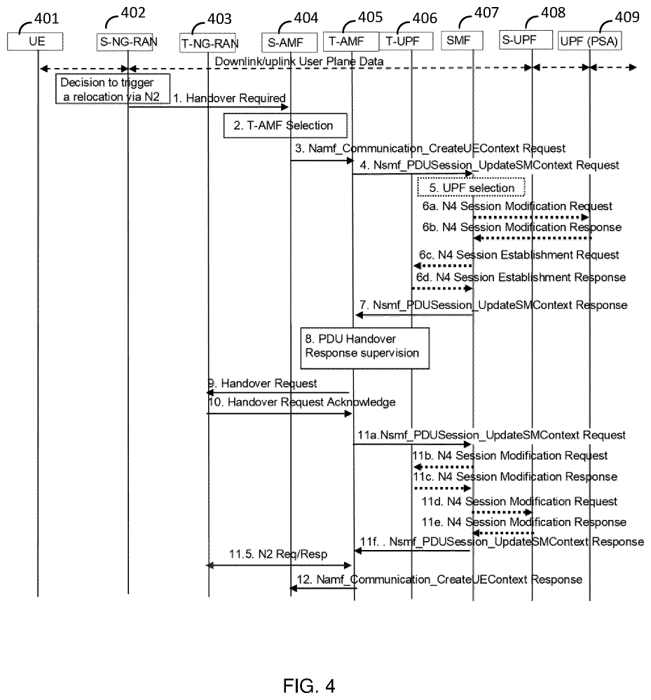

FIG. 4 is a message flow diagram illustrating an N2 handover according to some embodiments. Steps shown in FIG. 4 are described below.

1. A source RAN node 402 (S-NG-RAN) transmit to a source AMF (S-AMF) 404 a Handover Required message (the message includes: Target ID, Source to Target transparent container, SM N2 info list, Packet Data Unit (PDU) Session IDs, intra system handover indication).

The Source to Target transparent container includes NG-RAN information created by S-RAN to be used by the target RAN node 403 T-RAN, and is transparent to 5GC. It also contains for each PDU session the corresponding User Plane Security Enforcement information, QoS flows/DRBs information subject to data forwarding. It may also contain DAPS Information if DAPS handover is supported by S-RAN and S-AMF and DAPS handover is requested for one or more DRBs as described in 3GPP TS 38.300.

All PDU Sessions handled by S-RAN (i.e. all existing PDU Sessions with active UP connections) shall be included in the Handover Required message, indicating which of those PDU Session(s) are requested by S-RAN to handover. The SM N2 info includes Direct Forwarding Path Availability if direct data forwarding is available.

Direct Forwarding Path Availability indicates whether direct forwarding is available from the S-RAN to the T-RAN. This indication from S-RAN can be based on e.g. the presence of IP connectivity and security association(s) between the S-RAN and the T-RAN.

If the source NG RAN and target NG RAN support RACS as defined in TS 23.501, the Source to Target transparent container need not carry the UE radio access capabilities (instead the UE Radio Capability ID is supplied from the CN to the T-RAN). However, if the source NG-RAN has knowledge that the target NG-RAN might not have a local copy of the Radio Capability corresponding to the UE Radio Capability ID (i.e. because the source NG-RAN had itself to retrieve the UE's Radio Capability from the AMF) then the source NG-RAN may also send some (or all) of the UE's Radio Capability to the target NG-RAN (the size limit based on local configuration). In the case of inter-PLMN handover, when the source and target NG-RAN support RACS as defined in TS 23.501 and the source NG-RAN determines based on local configuration that the target PLMN does not support the UE Radio Capability ID assigned by the source PLMN, then the source NG-RAN includes the UE radio access capabilities in the Source to Target transparent container.

2. Target AMF (T-AMF) Selection: When the S-AMF can't serve the UE 401 anymore, the S-AMF selects the T-AMF as described in clause 6.3.5 on “AMF Selection Function” in 3GPP TS 23.501.

3. [Conditional] S-AMF to T-AMF: Namf_Communication_CreateUEContext Request (N2 Information (Target ID, Source to Target transparent container, SM N2 information list, PDU Session IDs), UE context information (Subscriber Permanent Identifier (SUPI), Service area restriction, Allowed Network Slice Selection Assistance Information (NSSAI) for each Access Type if available, Tracing Requirements, LTE M Indication, the list of PDU Session IDs along with the corresponding SMF information and the corresponding Single NSSAIs (S-NSSAI(s)), Policy Control Function (PCF) ID(s), Data Network Name (DNN), UE Radio Capability ID and UE Radio Capability Information). If the subscription information includes Tracing Requirements, the old AMF provides the target AMF (T-AMF) 405 with Tracing Requirements.

If the old AMF was a consumer of UE related Network Data Analytics Function (NWDAF) services, the old AMF includes information about active analytics subscriptions, i.e. the Subscription Correlation ID(s), NWDAF identifier(s) (i.e. Instance ID or Set ID), Analytic ID(s) and associated Analytics specific data in the Namf_Communication_UEContextTransfer request. Usage of the analytics information by the new AMF is specified in 3GPP TS 23.288.

In inter PLMN mobility case, UE context information includes Home PLMN (HPLMN) S-NSSAIs corresponding to the Allowed NSSAI for each Access Type, without Allowed NSSAI of source PLMN. The target AMF may determine the Allowed NSSAI based on the HPLMN S-NSSAIs received in step 3, or else the target AMF queries the Network Slice Selection Function (NSSF) by invoking Nnssf_NSSelection_Get service operation with the HPLMN S-NSSAIs and PLMN ID of Subscriber Permanent Identifier (SUPI). The target AMF may trigger AMF re-allocation when Mobility Registration Update is performed during the Handover execution phase as described in clause 4.2.2.2.3.

The S-AMF initiates Handover resource allocation procedure by invoking the Namf_Communication_CreateUEContext service operation towards the T-AMF.

When the S-AMF can still serve the UE, this step and step 12 are not needed.

If Service area restrictions are available in the S-AMF, they may be forwarded to the T-AMF as described in clause 5.3.4.1.2 in 3GPP TS 23.501.

If both Home and Visited PCF ID(s) are provided by the S-AMF, the T-AMF contacts the (V-)PCF identified by the (V-)PCF ID. If the (V-)PCF identified by the (V-)PCF ID is not used or there are no PCF ID(s) received from the S-AMF, the T-AMF may select the PCF(s) as described in clause 6.3.7.1 of 3GPP TS 23.501 and according to the V-NRF to H-NRF interaction described in clause 4.3.2.2.3.3. The T-AMF informs the S-AMF that the PCF ID is not used, as defined in step 12 and then the S-AMF terminates the AM Policy Association with the PCF identified by the PCF ID.

4. [Conditional] T-AMF to SMF: Nsmf_PDUSession_UpdateSMContext (PDU Session ID, Target ID, T-AMF ID, N2 SM Information).

For each PDU Session indicated by S-RAN, the AMF invokes the Nsmf_PDUSession_UpdateSMContext Request to the associated SMF 407. However, if the S-NSSAI associated with PDU Session is not available in the T-AMF, the T-AMF does not invoke Nsmf_PDUSession_UpdateSMContext for this PDU Session.

PDU Session ID indicates a PDU Session candidate for N2 Handover. Target ID corresponds to Target ID provided by S-RAN in step 1. SM N2 Info includes the Direct Forwarding Path Availability if the direct data forwarding is available between the S-RAN and the T-RAN and has been inserted by the S-RAN.

If the (T-)AMF detects that the UE moves into a non-allowed area based on Service area restrictions, the (T-)AMF notifies each NF consumer which has subscribed for UE reachability event (e.g. SMFs corresponding to the list of PDU Sessions received in UE Context from (S-)AMF via Namf_EventExposure_Notify that the UE is only reachable for regulatory prioritized services.

5. [Conditional] Based on the Target ID, SMF checks if N2 Handover for the indicated PDU Session can be accepted. The SMF checks also the UPF Selection Criteria according to clause 6.3.3 of 3GPP TS 23.501. If UE has moved out of the service area of the UPF connecting to NG-RAN, SMF selects a new intermediate UPF. If redundant transmission is performed for one or more QoS Flows of the PDU Session, the SMF selects two new Intermediate UPFs to support the redundant transmission based on two N3 and N9 tunnels between the T-RAN and the UPF (PDU Session Anchor (PSA)) 409 as described in clause 5.33.2.2 of 3GPP TS 23.501. In this case, step 6c and 6d are performed between SMF and each T-UPF.

In the case that the SMF fails to find a suitable I-UPF, the SMF decides to (based on local policies) either: trigger re-establishment of PDU Session. After handover procedure, SMF sends N1 message to the UE via the AMF by invoking Namf_Communication_N1N2Message Transfer containing the cause indicating PDU Session re-establishment is required for the UE; or keep the PDU Session, but reject the activation request of User Plane connection for the PDU Session and inform the AMF about it; or release the PDU Session after handover procedure.

6a. [Conditional] SMF to UPF (PSA): N4 Session Modification Request.

If the SMF selects a new UPF to act as intermediate UPF for the PDU Session, and the different CN Tunnel Info need be used, the SMF sends N4 Session Modification Request message to UPF (PSA). The SMF provides the CN Tunnel Info (on N9) if the CN Tunnel Info is allocated by the SMF, and UL Packet detection rules associate the CN Tunnel Info (on N9) to be installed on the UPF (PSA).

If redundant transmission is performed for one or more QoS Flows of the PDU Session and the different CN Tunnel Info need be used, the SMF provides two CN Tunnel Info (on N9) to the UPF (PSA) if the CN Tunnel Info is allocated by the SMF and indicates to the UPF (PSA) one of the CN Tunnel Info is used as redundancy tunnel of the PDU Session.

If indirect data forwarding is applied, based on indication from the S-RAN and if Access Control List is also applied based on operator configuration, the SMF decides to setup the indirect forwarding tunnel on the same UPF, the SMF also requests the UPF to allocate DL forwarding tunnel(s) for indirect forwarding. The SMF also indicates that the source address from UPF for forwarding tunnel between T-RAN and UPF is needed.

6b. [Conditional] UPF (PSA) to SMF: N4 Session Modification Response.

The UPF (PSA) sends an N4 Session Modification Response message to the SMF. If the UPF (PSA) allocates CN Tunnel Info (on N9) of UPF (PSA), it provides CN Tunnel Info (on N9) to the SMF. If redundant transmission is performed for one or more QoS Flows of the PDU Session, the UPF (PSA) provides two CN Tunnel Info (on N9) of UPF (PSA) to the SMF and indicates the SMF that one CN Tunnel Info is used as redundancy tunnel of the PDU Session as described in in clause 5.33.2.2 of 3GPP TS 23.501. The UPF (PSA) associate the CN Tunnel Info (on N9) with UL Packet detection rules provided by the SMF.

The UPF also provides the indirect forwarding N3 tunnel that includes UPF N3 address and Tunnel IDs for forwarding data, including the source address that UPF will use for the downlink packet delivery.

6c. [Conditional] SMF to Target UPF (T-UPF) (intermediate): N4 Session Establishment Request.

If the SMF selects a new intermediate UPF, i.e. the target UPF 406 (T-UPF), for the PDU Session and if CN Tunnel Info is allocated by the T-UPF, an N4 Session Establishment Request message is sent to the T-UPF, providing Packet detection, enforcement and reporting rules to be installed on the T-UPF. The CN Tunnel Info (on N9) of UPF (PSA) for this PDU Session, which is used to setup N9 tunnel, is also provided to the T-UPF.

If indirect data forwarding is applied, based on indication from the S-RAN and if Access Control List is also applied based on operator configuration, the SMF decides to setup the indirect forwarding tunnel on the same T-UPF, the SMF also requests the T-UPF to allocate DL forwarding tunnel(s) for indirect forwarding. The SMF also indicates that source address from T-UPF for forwarding tunnel between T-RAN and T-UPF is needed. Indirect forwarding may be performed via a UPF which is different from the T-UPF, in which case the SMF selects a T-UPF for indirect forwarding.

6d. T-UPF (intermediate) to SMF: N4 Session Establishment Response.

The T-UPF sends an N4 Session Establishment Response message to the SMF with DL CN Tunnel Info and UL CN Tunnel Info (i.e. N3 tunnel info). The SMF starts a timer to release the resource of the Source UPF (S-UPF), which is to be used in step 13a of the Execution Phase.

The T-UPF provides also the indirect forwarding N3 tunnel that includes T-UPF N3 address and Tunnel IDs for forwarding data, including the source address that T-UPF will use for the downlink packet delivery.

7. SMF to T-AMF: Nsmf_PDUSession_UpdateSMContext Response (PDU Session ID, N2 SM Information, Reason for non-acceptance).

If N2 handover for the PDU Session is accepted, the SMF includes in the Nsmf_PDUSession_UpdateSMContext response the N2 SM Information containing the N3 UP address and the UL CN Tunnel ID of the UPF, the QoS parameters and TSCAI for the Target NG-RAN. If redundant transmission is performed for one or more QoS Flows of the PDU Session, two UL CN Tunnel Info are included in the N2 SM Information. If the N2 SM information received at step 4 does not include the Direct Forwarding Path Availability and the SMF knows that there is no indirect data forwarding connectivity between source and target, the N2 SM Information includes a Data forwarding not possible indication. The SMF provides the N3 UP address and Tunnel IDs for indirect data forwarding, if received from UPF in step 6, as part of the N2 SM Information including the source address that UPF/T-UPF will use for the downlink packet delivery towards T-RAN. The SMF sends the Alternative QoS Profiles to the Target NG-RAN on a per QoS Flow basis, if available.

If N2 handover for the PDU Session is not accepted as described in step 5, the SMF does not include an N2 SM Information regarding the PDU Session to avoid establishment of radio resources at the target NG-RAN. Instead of that, the SMF provides a reason for non-acceptance. If the SMF has received notification from (T-) AMF that the UE is only reachable for regulatory prioritized services, the SMF does not include any N2 SM info regarding the PDU Session for non-regulatory prioritized services to avoid establishment of radio resources at the target NG-RAN. If the SMF receives notification from (T-) AMF that UE is only reachable for regulatory prioritized service after this step via Namf_EventExposure_Notify, the SMF deactivates the PDU Session after handover procedure finish if the PDU Session is not for regulatory prioritized services.

8. AMF supervises the Nsmf_PDUSession_UpdateSMContext Response messages from the involved SMFs. The lowest value of the Max delay indications for the PDU Sessions that are candidates for handover gives the maximum time AMF may wait for Nsmf_PDUSession_UpdateSMContext Response messages before continuing with the N2 Handover procedure. At expiry of the maximum wait time or when all Nsmf_PDUSession_UpdateSMContext Response messages are received, AMF continues with the N2 Handover procedure (Handover Request message in step 9).

NOTE: The delay value for each PDU Session is locally configured in the AMF and implementation specific.

9. T-AMF to T-RAN: Handover Request (Source to Target transparent container, N2 MM Information, N2 SM Information list, Tracing Requirements, UE Radio Capability ID). If the subscription information includes Tracing Requirements, the target AMF provides the target RAN with Tracing Requirements in the Handover Request.

T-AMF determines T-RAN based on Target ID. T-AMF may allocate a 5G-GUTI valid for the UE in the AMF and target TAI.

Source to Target transparent container is forwarded as received from S-RAN. N2 MM Information includes e.g. security information and Mobility Restriction List if available in the T-AMF.

N2 SM Information list includes N2 SM Information received from SMFs for the T-RAN in the Nsmf_PDUSession_UpdateSMContext Response messages received within allowed max delay supervised by the T-AMF mentioned in step 8.

Mobility Restriction List is sent in N2 MM Information if available in the T-AMF.

T-AMF provides the UE Radio Capability ID to T-RAN if RACS is supported. If the UE Radio Capability ID is included in the Handover Request message and no UE radio access capabilities are provided in the Source to Target transparent container, when there is no corresponding UE radio capabilities set for UE Radio Capability ID at T-RAN, T-RAN shall request the T-AMF to provide the UE radio capabilities set corresponding to UE Radio Capability ID to the T-RAN. If the Source to Target transparent container contains the UE radio access capabilities and the T-RAN did not receive the UE Radio Capability ID from the T-AMF, NG-RAN shall proceed with handover using the received UE radio access capabilities. If the T-RAN received both the UE radio access capabilities and the UE Radio Capability ID, then the T-RAN shall use any locally stored UE radio access capability information corresponding to the UE Radio Capability ID. If none are stored locally, the T-RAN may request the full UE radio access capability information from the core network. If the full UE radio access capability information is not promptly received from the core network, or the T-RAN chooses not to request them, then the T-RAN shall proceed with the UE radio access capabilities sent by the source RAN node. The T-RAN shall not use the UE radio access capability information received from the source RAN node for any other UE with the same the UE Radio Capability ID.

If DL data forwarding tunnel information is provided (as part of the N2 SM info in step 7/9 above), T-RAN may use the source address, that UPF/T-UPF will use for the downlink packet delivery, for ACL as specified in TS 38.413.

10. T-RAN to T-AMF: Handover Request Acknowledge (Target to Source transparent container, List of PDU Sessions to Hand-over with N2 SM information, List of PDU Sessions that failed to be established with the failure cause given in the N2 SM information element).

Target to Source transparent container includes a UE container with an access stratum part and a NAS part. The UE container is sent transparently via T-AMF, S-AMF and S-RAN to the UE. If DAPS handover is supported by the T-RAN and T-AMF and the DAPS Information for one or more DRBs had been received in the Source to Target Transparent Container, the T-RAN includes the DAPS Response information in the Target to Source Transparent Container.

T-RAN creates List Of PDU Sessions failed to be setup and reason for failure (e.g. T-RAN decision, S-NSSAI is not available, unable to fulfil User Plane Security Enforcement) based on T-RAN determination. The information is provided to the S-RAN.

The N2 SM information in the List Of PDU Sessions to Hand-over, contains per each PDU Session ID T-RAN N3 addressing information i.e. N3 UP address and Tunnel ID of T-RAN for the PDU Session.

If redundant transmission is performed for one or more QoS Flows of the PDU Session, the T-RAN provides two Access Network (AN) Tunnel Info for the PDU Session in the N2 SM information. The T-RAN indicates to the SMF one of the AN Tunnel Info is used as the redundancy tunnel of the PDU session. If only one AN Tunnel Info is provided by the Target NG-RAN for the PDU session, the SMF may release these QoS Flows by triggering PDU Session Modification procedure as specified in clause 4.3.3 after the handover procedure.

The N2 SM information may also include: an Indication whether UP integrity protection is performed or not on the PDU Session; if the PDU Session has at least one QoS Flow subject for data forwarding, N3 UP address and Tunnel ID of T-RAN for receiving forwarded data. The T-RAN provides data forwarding addresses for each data forwarding tunnel which it decided to setup; For each QoS Flow accepted with an Alternative QoS Profile, the Target NG-RAN shall include a reference to the fulfilled Alternative QoS Profile.

11a. AMF to SMF: Nsmf_PDUSession_UpdateSMContext Request (PDU Session ID, N2 SM response received from T-RAN in step 10).

For each N2 SM response received from the T-RAN (N2 SM information included in Handover Request Acknowledge), AMF sends the received N2 SM response to the SMF indicated by the respective PDU Session ID.

If no new T-UPF is selected, SMF stores the N3 tunnel info of T-RAN from the N2 SM response if N2 handover is accepted by T-RAN.

If SMF/UPF supports indirect data forwarding, the SMF/UPF allocates the N3 UP address and Tunnel IDs for indirect data forwarding corresponding to the data forwarding tunnel endpoints established by T-RAN as specified in step 11, unless SMF/UPF already allocated the N3 UP address and Tunnel IDs for indirect data forwarding in step 6/7.

If a PDU Session is indicated as a rejected PDU Session by the Target NG-RAN with an indication that the PDU session was rejected because User Plane Security Enforcement is not supported in the Target NG-RAN and the User Plane Enforcement Policy indicates “Required,” the SMF triggers the release of this PDU Session. In all other cases of PDU Session rejection, the SMF can decide whether to release the PDU Session (possibly triggering the re-establishment of the PDU Session as described in step 5) or to deactivate the UP connection of this PDU Session.

If some of the QoS Flows of a PDU Session are not accepted by the Target NG-RAN, the SMF shall initiate the PDU Session Modification procedure to remove the non-accepted QoS Flows from the PDU Session(s) after the handover procedure is completed.

11b. [Conditional] SMF to T-UPF: N4 Session Modification Request (T-RAN SM N3 forwarding Information list, indication to allocate DL forwarding tunnel(s) for indirect forwarding)

If the SMF selected a T-UPF in step 6a, the SMF updates the T-UPF by providing the T-RAN SM N3 forwarding information list by sending a N4 Session Modification Request to the T-UPF.

If indirect forwarding applies based on indication from the S-RAN and the UPF is re-allocated and if the SMF decides to setup the indirect forwarding tunnel on the same T-UPF, the SMF also requests in the N4 Session Modification Request message to the T-UPF, to allocate DL forwarding tunnel(s) for indirect forwarding unless it's already performed during step 6 and 7.

Indirect forwarding may be performed via a UPF which is different from the T-UPF, in which case the SMF selects a T-UPF for indirect forwarding unless it's already performed during step 6 and 7.

To support the alternative in step 11.5, the SMF also indicates that source address from T-UPF for forwarding tunnel between target T-UPF and T-RAN is needed in the message.

11c. [Conditional] T-UPF to SMF: N4 Session Modification Response (T-UPF SM N3 forwarding Information list).

The T-UPF allocates Tunnel Info and returns an N4 Session Modification Response message to the SMF.

The T-UPF SM N3 forwarding info list includes T-UPF N3 address, T-UPF N3 Tunnel identifiers for forwarding data unless it's already performed during step 6 and 7.

The T-UPF provides also the source address that T-UPF will use for the downlink packet delivery.

11d. [Conditional] SMF 407 to S-UPF 408: N4 Session Modification Request (T-RAN SM N3 forwarding Information list or T-UPF SM N3 forwarding Information list, indication to allocate DL forwarding tunnel(s) for indirect forwarding).

If the UPF is re-allocated, this message includes the T-UPF SM N3 forwarding info list. If the UPF is not re-allocated, this message includes the T-RAN SM N3 forwarding info list.

If indirect forwarding applies based on indication from NG-RAN and UPF allocates tunnel identities, the SMF indicates in the N4 Session Modification Request message to the S-UPF to allocate DL forwarding tunnel(s) for indirect forwarding.

To support the alternative in step 11.5, the SMF also indicates that source address from S-UPF for forwarding tunnel between target S-UPF and T-RAN is needed in the message.

Indirect forwarding may be performed via a UPF which is different from the S-UPF.

11e. [Conditional] S-UPF to SMF: N4 Session Modification Response (S-UPF SM N3 forwarding Information list).

The S-UPF allocates Tunnel Info and returns an N4 Session establishment Response message to the SMF.

The S-UPF SM N3 forwarding Information list includes S-UPF N3 address, S-UPF N3 Tunnel identifiers for DL data forwarding.

The S-UPF provides also the source address that T-UPF will use for the downlink packet delivery.

11f. SMF to T-AMF: Nsmf_PDUSession_UpdateSMContext Response (N2 SM Information).

The SMF sends an Nsmf_PDUSession_UpdateSMContext Response message per PDU Session to T-AMF.

The SMF creates an N2 SM information containing the DL forwarding Tunnel Info to be sent to the S-RAN by the AMF. The SMF includes this information in the Nsmf_PDUSession_UpdateSMContext response. The DL forwarding Tunnel Info can be one of the following information: (1) If direct forwarding applies, then the SMF includes the T-RAN N3 forwarding information the SMF received in step 11a; (2) If the indirect forwarding tunnel is setup in step 11b or 11d, then the SMF includes the T-UPF or S-UPF DL forwarding information containing the N3 UP address and the DL Tunnel ID of the UPF.

If indirect data forwarding with ACL is supported and source address for the data forwarding tunnel is received from UPF/T-UPF/S-UPF in the steps above, the SMF creates an additional N2 SM information containing the DL forwarding Tunnel Info with source address information to be sent to the T-RAN by the AMF. The SMF includes also this information in the Nsmf_PDUSession_UpdateSMContext response.

11.5. The AMF sends the NGAP PDU Session Resource Modification Request message, including the additional N2 SM information containing the DL forwarding tunnel Info for T-RAN, if it's received from SMF in step 11f above. T-RAN responds with NGAP PDU session Resource Modification Response message. The NGAP message above is just an example; it can be a new message or other existing message.

If DL data forwarding Tunnel info is provided, target RAN may use the source address, that UPF/T-UPF/S-UPF will use for the downlink packet delivery, for ACL as specified in TS 38.413.

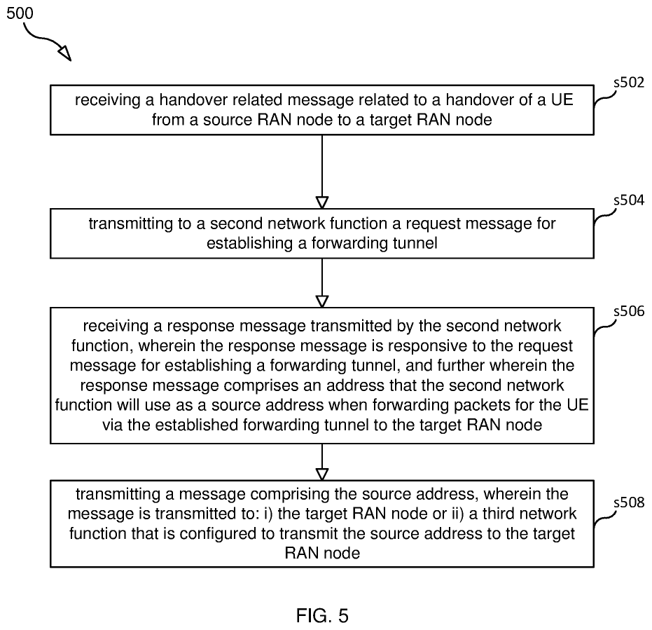

FIG. 5 is a flowchart illustrating a process 500, according to an embodiment, that is performed by a first network function (e.g., MME 304, MME 305, SMF 407). Process 500 may begin in step s502.

Step s502 comprises receiving a handover related message related to a handover of a UE 301 from a source RAN node 302 to a target RAN node 304.

Step s504 comprises, after receiving the handover related message, transmitting to a second network function (e.g., SGW 306, SGW 307, UPF 406, UPF 409) a request message for establishing a forwarding tunnel.

Step s504 comprises receiving a response message transmitted by the second network function, wherein the response message is responsive to the request message for establishing a forwarding tunnel, and further wherein the response message comprises an address that the second network function will use as a source address when forwarding packets for the UE via the established forwarding tunnel to the target RAN node.

Step s508 comprises, after receiving the response message, transmitting a message comprising the source address, wherein the message is transmitted to: i) the target RAN node or ii) a third network function (e.g., AMF 404 or AMF 405) that is configured to transmit the source address to the target RAN node.

In some embodiments, the message comprising the source address is a Handover Request, and the Handover Request is transmitted to the target RAN node.

In some embodiments, the message comprising the source address is an S1 control plane (S1-CP) message, and the S1-CP message is transmitted to the target RAN node.

In some embodiments, the S1-CP message is an E-RAB Modify Request.

In some embodiments, the process also includes, after receiving the handover related message and prior to transmitting to the target RAN node the S1-CP message comprising the source address, transmitting to the target RAN node a Handover Request.

In some embodiments, the request message for establishing the forwarding tunnel is a Create Indirect Data Forwarding Tunnel Request.

In some embodiments, the handover related message is: a Handover Required message, or a Forward Relocation Request.

In some embodiments, the first network function is a Long Term Evolution (LTE) Mobility Management Entity (MME). In some embodiments, the second network function is an LTE Serving Gateway (SGW).

In some embodiments, the message comprising the source address is a session update response that is responsive to a session update request transmitted by an AMFs, and the session update response is transmitted to the AMF.

In some embodiments, the message comprising the source address is transmitted to an AMF, and the message comprising the source address is a response message that is responsive to a request transmitted by the AMF (e.g., the request transmitted by the AMF is a Nsmf_PDUSession_UpdateSMContext request or a Nsmf_PDUSession_CreateSMContext request; and the response transmitted by the SMF is either a Nsmf_PDUSession_UpdateSMContext response or a Nsmf_PDUSession_CreateSMContext response).

In some embodiments, the request message for establishing the forwarding tunnel is a session establishment request or a session modification request.

In some embodiments, the handover related message is a Nsmf_PDUSession_UpdateSMContext request or Nsmf_PDUSession_CreateSMContext request.

In some embodiments, the first network function is a 5G Session Management Function (SMF). In some embodiments, the second network function is a 5G User Plane Function (UPF). In some embodiments, the UPF is an anchor UPF or an intermediate UPF.

In some embodiments, the request message for establishing the forwarding tunnel indicates that a source address of the forwarding tunnel is required.

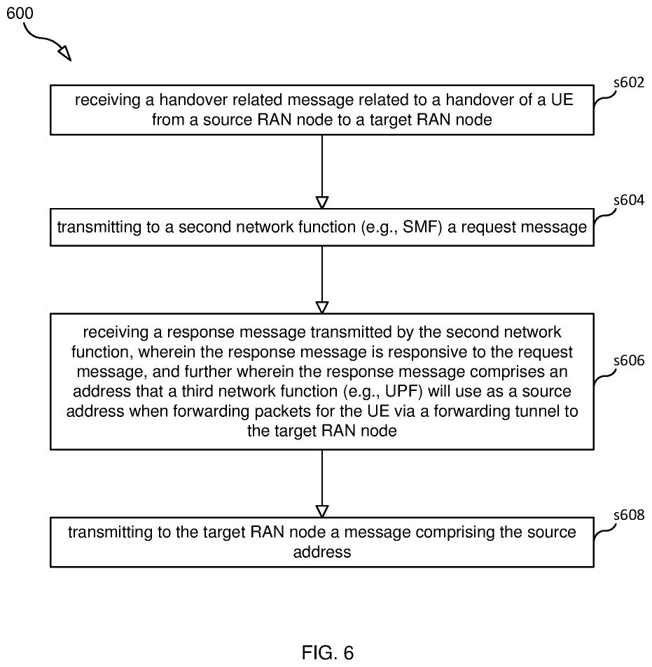

FIG. 6 is a flowchart illustrating a process 600, according to an embodiment, that is performed by a first network function (e.g., AMF 404 or AMF 405). Process 600 may begin in step s602.

Step s602 comprises receiving a handover related message related to a handover of a UE from a source RAN node to a target RAN node.

Step s604 comprises, after receiving the handover related message, transmitting to a second network function (e.g., SMF) a request message.

Step s606 comprises receiving a response message transmitted by the second network function, wherein the response message is responsive to the request message, and further wherein the response message comprises an address that a third network function (e.g., UPF) will use as a source address when forwarding packets for the UE via a forwarding tunnel to the target RAN node.

Step s608 comprises, after receiving the response message, transmitting to the target RAN node a message comprising the source address.

In some embodiments, the handover related message is: a Handover Required message, or a request for creating a UE context (e.g. Namf_communication_CreateUEContext request).

In some embodiments, the second network function is a Session Management Function, and the request message transmitted to the second network function is a Nsmf_PDUSession_UpdateSMContext request or Nsmf_PDUSession_CreateSMContext request.

In some embodiments, the message transmitted to the target RAN node is a Handover Request.

In some embodiments, the message transmitted to the target RAN node is a Next Generation Application Protocol, NGAP, message (e.g., an NGAP PDU Session Resource Modification Request).

At least some of the embodiments described above may be related to and/or used in combination with embodiments disclosed in U.S. provisional patent application No. 63/256,160, filed on Oct. 15, 2021, titled “SUPPORT FOR GTP-U SOURCE IP ADDRESS AWARENESS”. For example, at least some of the above embodiment outlined provide ACL control without impacting the S1 and N2 handover procedure thereby eliminating a potential security issue in the S1 and N2 handover procedure, while embodiments disclosed in the '160 application provide the advantage of enabling ACLs to be enforced in RAN (e.g., based on what valid GTP-U source IP addresses are used by the user plane (e.g., UPF) as well as additionally or alternatively providing the advantage of enabling ACLs to be enforced in the user plane (e.g., UPF) based on what valid GTP-U source IP addressed are used by RAN or other user planes (e.g., UPFs). Accordingly, relevant portions of this provisional patent application are provided below.

Access control functionality (a.k.a., ACL functionality) is supported for data handling between a source RAN node and target RAN node for the X2 and Xn communications.

The source RAN side provides the communication tunnel information to the target RAN side in advance. The target RAN side then uses the information to control the incoming traffic from the source side during the X2 or Xn handover (e.g., accept only the traffic from communication tunnel provided by the source RAN side previously). The ACL functionality is defined in 3GPP TS 36.413 V16.6.0 (“TS 36.413”). As stated in TS 36.413, “ACL Functionality” is “a functionality controlling the access to network nodes. In case of Access Control Lists (ACL) functionality is applied in a network node the network node may only accept connections from other peer network nodes once the source addresses of the sending network node is already known in the target node.”

In current 3GPP technical specifications, the source RAN addresses are transferred to the target RAN addresses at the time of X2/Xn address discovery. Namely, the user plane (UP) addresses that a source RAN may use are signalled to a target RAN via the core network (CN), as part of e.g. the Next Generation (NG) Application Protocol (NGAP) Mobility Management Entity (MME) Configuration Transfer message. As stated in TS 36.413, “[i]f the eNodeB receives, in the SON Configuration Transfer [Information Element (IE)], the X2 TNL Configuration Info IE containing the [Evolved Node B (eNodeB)] X2 Extended Transport Layer Addresses (IE), it may use it as part of its ACL functionality configuration actions, if such ACL functionality is deployed.”

During RAN3-113e, some further use cases were highlighted, which need standardization changes in order to support ACL. These use cases require that the source Internet Protocol (IP) address for user data traffic sent from the Core Network (CN) to RAN is made known to RAN. In that way, RAN can check the incoming traffic and ensure that it only comes from source IP addresses that have been previously been notified to RAN.

All user plane traffic sent between RAN and CN is encapsulated in the General Packet Radio System (GPRS) Tunneling Protocol User Plane (GTP-U). In GTP-U, only the destination IP address and Tunnel Endpoint Identifier (TEID) are significant when receiving a packet. That is, the receiver of a GTP-U-encapsulated packet (e.g., RAN) will examine the destination IP address and TEID in order to determine what UE context the GTP-U packet belongs to, and know how to process and forward the encapsulated packet. The source address is not used in this process. Therefore, when establishing GTP-U tunnels between CN and RAN, only destination IP addresses and TEIDs are negotiated between the tunnel endpoints. The sender can then use any source IP address it wishes.

Aspects of the present invention may provide a mechanism to enable verification of the source IP address(es) of GTP-U payload packets. Aspects of the present invention may provide a mechanism for the control plane (e.g., SMF) to request GTP-U source IP addresses used and/or a mechanism for control plane to provide the GTP-U source IP addresses to GTU-U for access control list (ACL) control.

Aspects of the present invention may provide the advantage of enabling ACLs to be enforced in RAN (e.g., based on what valid GTP-U source IP addresses are used by the user plane (e.g., UPF). Aspects of the present invention may additionally or alternatively provide the advantage of enabling ACLs to be enforced in the user plane (e.g., UPF) based on what valid GTP-U source IP addressed are used by RAN or other user planes (e.g., UPFs).

In some aspects, based on different input information (e.g., random access technology (RAT) type, public land mobile network (PLMN) identification (ID), slice information, quality of service (QOS) parameters), the SMF may request the UPF to provide one or more source IP addresses or a set of source IP addresses per Network Instance, per Network Slice, and/or per Destination interface. In some aspects, the one or more source IP addresses may be used to send GTP-U payload packets towards the peer GTP-U entity for a packet data network (PDN) connection and/or a protocol data unit (PDU) session. In some aspects, the Network Slice may be identified by Single Network Slice Selection Assistance Information (S-NSSAI). In some aspects, the set of source IP addresses per Network Instance, per Network Slice, and/or per Destination interface may be used to send GTP-U payload packets towards the Network Instance, the Network Slice, or the Destination interface.

In some aspects, the SMF may provide to the UPF the remote peer GTP-U entities one or more source IP addresses or a set of source IP addresses from remote peer GTP-U entities per Network Instance, per Network Slice, and/or per source interface. In some aspects, the one or more source IP addresses may be used by the remote peer GTP-U entity to send GTP-U payload packets towards this UPF for a given PDN connection and/or a PDU session. In some aspects, the Network Slice may be identified by a S-NSSAI.

In the aspects above, the SMF and UPF are used as examples of Control Plane and User plane, respectively, but aspects of the invention also apply to SGW-C and SGW-U, PGW-C and PGW-U, and combined nodes such as PGW/SGW-C and PGW/SGW-U as well as PGW-C/SMF.

### 1.1 Per Session Source IP Address Handling

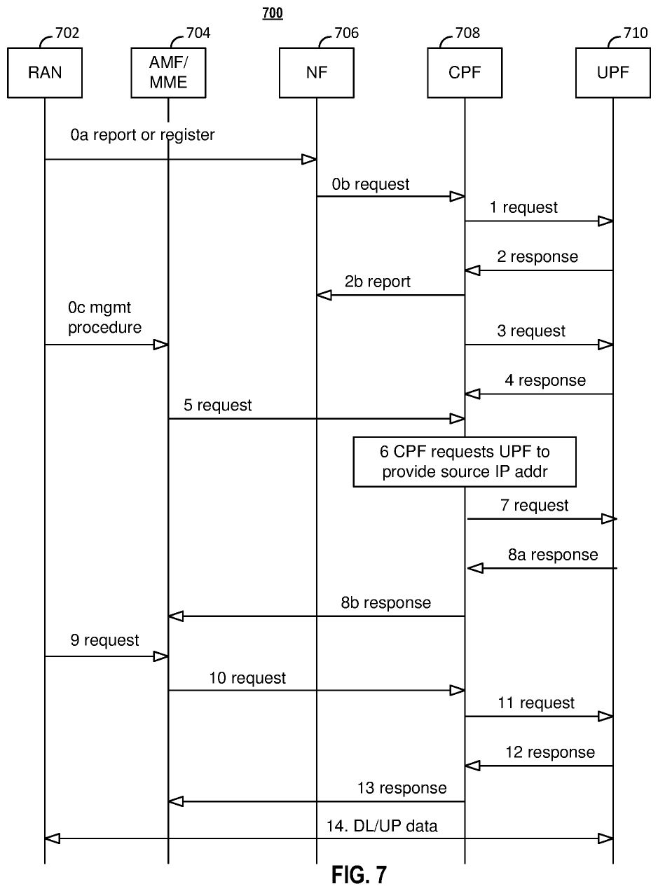

FIG. 7 is a message flow diagram illustrating a per-session source IP address handling process 700 according to some aspects. Steps shown in FIG. 7 are described below.

In some aspects, the process 700 may include a step Oa in which a radio access network (RAN) 702 (e.g., a next generation RAN (NG-RAN) or an Evolved Universal Mobile Telecommunications Service (UMTS) Terrestrial RAN (E-UTRAN) reports or registers a set of one or more source IP addresses to be used to send a GTP-U payload packet towards a Network Instance (NI), a Network Slice (NS), or a GTP-U peer. In some aspects, the one or more source IP addresses may be reported to or registered in a network function 706 that includes a firewall function.

In some aspects, the process 700 may include a step Ob in which the network function 706 requests a control plane (CP) function 708 (e.g., a session management function (SMF), a serving gateway (SGW) control plane function (SGW-C), a packet gateway (PGW) control plane function (PGW-C), a PGW/SGW-C, a PGW-C/SMF, or a multicast broadcast (MB) SMF (MB-SMF)) to collect a set of source IP addresses to be used to send GTP-U payload packet a NI, NS, or a GTP-U peer.

In some aspects, the process 700 may include a step 1 in which the CP function 708 sends a packet forwarding control protocol (PFCP) association setup request. In some aspects, the PFCP association setup request may be received by a user plane (UP) function 710 (e.g., a user plane function (UPF), an SGW user plane function (SGW-U), a PGW user plane function (PGW-U), a PGW/SGW-U, or an MB-UPF). In some aspects, the PFCP association setup request may include an indication to report the available source IP addresses used to send GTP-U payload packets per NI, (, and/or per UP function node.

In some aspects, the process 700 may include a step 2 in which the UP function 710 sends a PFCP association setup response. In some aspects, the PFCP association setup response may be received by the CP function 708. In some aspects, the PFCP association setup response may include an indication that the UP function 710 supports verification of one or more source IP addresses. In some aspects, verification of source IP address may include providing the one or more source IP addresses and verifying that the GTP-U payload packets received at a local Fully Qualified Tunnel Endpoint Identifier (F-TEID) are sent from designated/announced source IP addresses.

In some aspects, the process 700 may include a step 2b in which the CP function 708 reports a set of one or more source IP addresses to be used to send a GTP-U payload packet toward an NI, an NS, or a GTP-U peer. In some aspects, the step 2b may include the network function 706 with the firewall function receiving the set of one or more source IP addresses.

In some aspects, the process 700 may include a step 0c in which an S1 or Next Generation Application Procedure (NGAP) interface management procedure is performed. In some aspects, the S1 or NGAP interface management procedure may include using S1 Setup or NGAP Setup to report a set of one or more source IP addresses from the RAN 702 to send GTP-U payload packets toward the Core Network (e.g., toward an Access and Mobility Management Function (AMF) or Mobility Management Entity (MME) 704) per NI or per NS.

In some aspects, the process 700 may include a step 3 in which the CP function 708 sends a PFCP association update request, which may be received by the UP function 710. In some aspects, the PFCP association update request may include a list of one or more source IP addresses that are used to send GTP-U payload packets per NI and/or per NS to the Core Network. In some aspects, the one or more source IP addresses from a peer GTP-U (e.g., RAN 702).

In some aspects, the process 700 may include a step 4 in which the UP function 710 sends a PFCP association update response, which may be received by the CP function 708. In some aspects, the PFCP association update response may acknowledge the PFCP association update request sent in step 3. In some aspects, the PFCP association update response may indicate that the UP function 710 will verify the receiving GTP-U payload packets against the one or more source IP addresses.

In some aspects, the process 700 may include a step 5 in which the AMF/MME 704 sends a Create Session Request or a Create SmContext Request to create a packet data network (PDN) connection or a protocol data unit (PDU) session. In some aspects, the step 5 may include the CP function 708 receiving the Create Session Request or the Create SmContext Request.

In some aspects, the process 700 may include a step 6 in which the CP function 708 requests the UP function 710 to provide the source IP address for a specific GTP-U tunnel during PFCP session signaling. In some aspects, the CP function 708 requests the UP function 710 to provide the source IP address for a specific GTP-U tunnel during PFCP session signaling in response to the CP function 708 receiving a request to create a PDN connection or a PDU session (e.g., in step 5).

In some aspects, the process 700 may include a step 7 in which the CP function 708 sends a PFCP session establishment request, which may be received by the UP function 710. In some aspects, the PFCP session establishment request may include (i) an indication (e.g., in uplink (UL) packet detection rule (PDR)) to verify a source IP address, which will be provided in a step 9 of the process 700, (ii) an indication (e.g., in downlink (DL) Forwarding Action Rule (FAR)) for requesting the UP function 710 to provide one or more source IP addresses to send GTP-U packet in downlink (DL) direction, and/or (iii) instructions to, if the source IP address of the packet is not verified, discard and/or report to the CP function 708 and/or to the network function 706 that includes a firewall function.

In some aspects, the process 700 may include a step 8a in which the UP function 710 creates a PDR, a local F-TEID to receive UL GTP-U packet payload, and/or a new Created FAR Information Element (IE), which may contain the one or more source IP addresses used for the GTP-U tunnel. In some aspects, step 8 may include the UP function 710 sending a PFCP session establishment response, which may be received by the CP function 708. In some aspects, the PFCP session establishment response may include the created PDR, the local F-TEID to receive UL GTP-U packet payload, and/or the Created FAR IE.

In some aspects, the process 700 may include a step 8b in which the CP function 708 sends a Create Session Response or a Create SmContext Response, and the AMF/MME 704 receives the Create Session Response or the Create SmContext Response. In some aspects, the Create Session Response or the Create SmContext Response may include the one or more source IP addresses allocated by the UP function 710 (e.g., in step 8a).

In some aspects, the process 700 may include a step 9 in which the RAN 702 sends an Initial User Equipment (UE) Context Setup or E-UTRAN Radio Access Bearer (E-RAB) Establishment Request or a PDU Session Resource Setup Request, which may be received by the AMF/MME 704. In some aspects, the Initial UE Context Setup or E-RAB Establishment Request or PDU Session Resource Setup Request may include the one or more source IP addresses to be used by the Core Network (e.g., the UP function 710).

In some aspects, the process 700 may include a step 10 in which the AMF/MME 704 sends a Modify Bearer Request or an Update SmContext Request, which may be received by the CP function 708. In some aspects, the Modify Bearer Request or the Update SmContext Request may include the one source IP addresses provided by the RAN 702 when the RAN 702 sends the uplink GTP-U payload information towards the Core Network.

In some aspects, the process 700 may include a step 11 in which the CP function 708 sends a PFCP Session Modification Request, which may be received by the UP function 710. In some aspects, the PFCP Session Modification Request may include updating the UL PDR to provide the one or more source IP addresses provided by the RAN 702.

In some aspects, the process 700 may include a step 12 in which the UP function 710 sends a PFCP Session Modification Response, which may be received by the CP function 708. In some aspects, the PFCP Session Modification Response may indicate that the UP function 710 accepted the update to the UL PDR.

In some aspects, the process 700 may include a step 13 in which the CP function 708 sends a Modify Bearer Response or an Update SMContext Response, which may be received by the AMF/MME 704. In some aspects, the Modify Bearer Response or the Update SMContext Response may indicate that the update to the UL PDR to provide the one or more source IP addresses provided by the RAN 702 was accepted.

In some aspects, the process 700 may include a step 14 in which the downlink (DL) and/or uplink (UL) payload packets transferred between the RAN 702 and the UP function 710 are verified against the source IP addresses, respectively.

### 1.2 Per-Node Source IP Address Handling

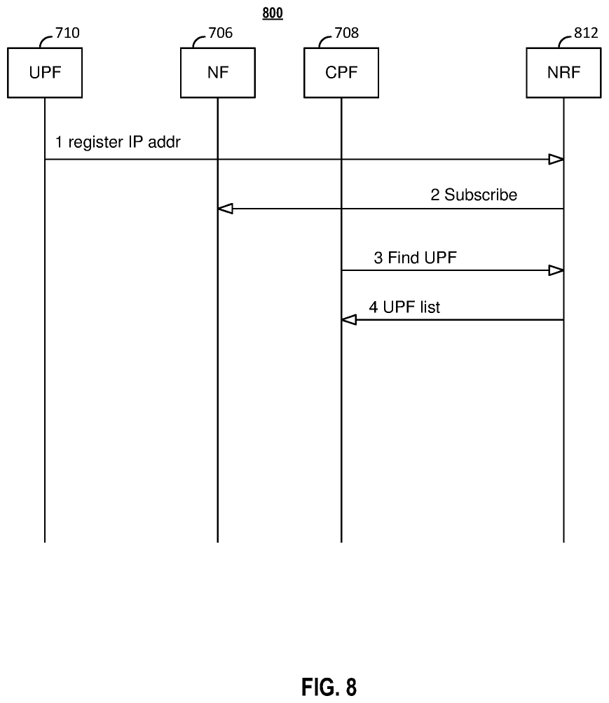

FIG. 8 is a message flow diagram illustrating a per-node source IP address handling process 800 according to some aspects. Steps shown in FIG. 8 are described below.

In some aspects, the process 800 may include a step 1 in which the UP function 710 registers in the Network Repository Function (NRF) 812 the one or more source IP addresses to be used towards per NI, per NS, and/or per Interface via invoking the NRF Network Function (NF) Management or via the Operations, Administration, and Maintenance (OAM).

In some aspects, the process 800 may include a step 2 in which the network function 706 that includes a firewall function subscribes with the NRF 812 to receive any change to the one or more source IP addresses for any UP function 710, any NI, or any NS.

In some aspects, the process 800 may include a step 3 in which, when establishing a user plane connection and/or selecting a UP function (e.g., UPF) for a PDN connection/PDU session, the CP function 708 invokes the NF Discovery Application Programming Interface (API) of the NRF 812 to find a UP function. In some aspects, the CP function 708 may include the one or more source IP addresses that will be used by the UP function.

In some aspects, the process 800 may include a step 4 in which the NRF 812 returns a list of candidate UP functions. In some aspects, the NRF 812 may include the source IP addresses of the candidate UP functions.

### 2.1 Control Plane Entity Requests GTP-U Entity to Provide Source Address Information

Different options for notifying the CP function 708 (e.g., SMF) about the valid GTP-U source IP addresses are described below. In some aspects, the different options may be based on different input information (e.g., random access technology (RAT) type, public land mobile network (PLMN) identification (ID), slice information, quality of service (QOS) parameters).

Option 1: In some aspects, the one or more GTP-U source IP addresses may be provided for each Forwarding Action Rule (FAR) that is installed in UPF. In some aspects, the CP function 708 (e.g., SMF) may indicate in the FAR that the one or more source IP addresses are requested. In some aspects, the UP function 710 (e.g., UPF) may inform the CP function 708 what source IP address(es) will be used for the traffic that is forwarded by that FAR. In some aspects, the UP function 710 may provide the one or more source IP addresses in a Created FAR Information Element (IE). This option for the CP function 708 to request and the UP function 710 to provide one or more source IP addresses is described with reference to steps 7 and 8a of the process 700 illustrated in FIG. 7.

Option 2: In some aspects, the one or more GTP-U source IP address may be provided for each Network Instance and/or each Network Slice that is supported by the UP function 710 (e.g., UPF). In some aspects, the CP function 708 (e.g., SMF) may indicate in the PFCP Association Establishment Setup procedure that one or more GTP-U source IP addresses are requested. In some aspects, the UP function 710 (e.g., UPF) may provide the set of one or more GTP-U source IP addresses that are used per Network Instance and/or per Network Slice. This option for the CP function 708 to request and the UP function 710 to provide one or more source IP addresses is described with reference to steps 1 and 2 of the process 700 illustrated in FIG. 7.

Option 3: In some aspects, the one or more GTP-U source IP addresses may be provided for each Destination Interface (e.g., “Access”, “Core”) that is supported by the UP function 710 (e.g., UPF). In some aspects, the CP function 708 (e.g., SMF) may indicate in the PFCP Association Establishment Setup procedure that one or more GTP-U source IP addresses are requested. In some aspects, the UP function 710 may provides the set of one or more GTP-U source IP addresses that are used per Destination Interface. This option for the CP function 708 to request and the UP function 710 to provide one or more source IP addresses is described with reference to steps 1 and 2 of the process 700 illustrated in FIG. 7.

Option 4: In some aspects, the one or more GTP-U source IP addresses may be provided for each UP function 710 (e.g., UPF). In some aspects, the CP function 708 (e.g., SMF) may indicate in the PFCP Association Establishment Setup procedure that one or more GTP-U source IP addresses are requested. In some aspects, the UP function 710 may provide the set of one or more GTP-U source IP addresses that are used by the UP function 710. This option for the CP function 708 to request and the UP function 710 to provide one or more source IP addresses is described with reference to steps 1 and 2 of the process 700 illustrated in FIG. 7.

In some alternative aspects for Options 2, 3 and 4, UP functions 710 (e.g., UPFs) registers in the NRF 812 its one or more source IP addresses per Network Instance, per Network Slice, and/or per UPF function. In some aspects, the registration of the one or more source IP addresses enables other network functions (e.g., CP function 708) to retrieve the one or more source IP addresses registered by the UP functions 710 (e.g., when selecting a UP function 710 for a PDN connection. This alternative option for the CP function 708 to receive from the NRF 812 one or more source IP addresses that have been registered in the NRF 812 by a UP function 710 is described with reference to steps 1-4 of the process 800 illustrated in FIG. 8.

In some aspects for Options 2, 3 and 4, UP function 710 (e.g., UPF) may be capable of configuring only one source IP address for a given Network Instance or a given Network Slice.

In some aspects, after the CP function 708 (e.g., SMF) receives the one or more source IP addresses provided by the UP function 710 (e.g., UPF), the CP function 708 may provide the one or more source IP addresses to the entity that does the source IP address verification (e.g., the remote peer GTP-U entity, a RAN GTP-U entity, and/or a network function 706 that has a firewall function).

In some aspects, the network function 706 with the firewall function may collect the source IP addresses of GTP-U entities, either via (a) requesting those GTP-U entities to report their source IP addresses (pull mechanism) (see FIG. 7) or (b) those GTP-U entities can register their source IP addresses per network instance, per network slice, and/or per node in the new network function 706 (push mechanism) (see FIG. 8).

### 2.2 Control Plane Entity Provides Source Addresses Information of the Remove GTP-U Entities

Different options for a CP function 708 (e.g., SMF) that has received source IP addresses of remote GTP-U entities to provide the source IP addresses of the remote peer GTP-U entities to the UP function 710 (e.g., UPF) are described below.

Option 1: In some aspects, the CP function 708 (e.g., SMF) may provide the one or more source IP addresses of a remote peer GTP-U entity corresponding to the Local GTP-U tunnel endpoint (to receive the GTP-U payload packets) in the Packet Detection Rules (PDR) that are installed in UPF for a given PDN connection/PDU session. In some aspects, the CP function 708 (e.g., SMF) may provide an indication to request the UP function 710 (e.g., UPF) to verify the GTP-U payload packets received at the local Tunnel End point using the provided one or more source IP addresses. In some aspects, the CP function 708 may provide UP function 710 (e.g., UPF) with instructions for those packets having a source IP address that does not matching any of the provided one or more source IP addresses. In some aspects, the instructions may include DISCARD, FORWARD, DISCARD/FORWARD, and/or REPORT. In some aspects, (i) the PDR including the one or more source IP addresses of the remove peer GTP-U entity, (ii) the indication requesting the UP function 710 to verify the received GTP-U payload packets, and (iii) the instructions for GTP-U payload packets have a source IP address that does not match, may be provided in different signaling messages. This option for the CP function 708 to provide the source IP addresses of the remote peer GTP-U entities to the UP function 710 (e.g., UPF) is described with reference to steps 7 and 8 of the process 700 illustrated in FIG. 7.

Option 2: In some aspects, the CP function 708 (e.g., SMF) may provide the one or more source IP addresses of a remote peer GTP-U entity, which are used as the source IP address of GTP-U payload packets received for a given Network Instance and/or Network Slice that is supported by the UP function 710 (e.g., UPF). In some aspects, the CP function 708 may provide these one or more source IP address in the PFCP Association Establishment Setup or Update procedure and request the UP function 710 to accept the packets only from these one or more source IP addresses for the Network Instance and/or the Network Slice. This option for the CP function 708 to provide the source IP addresses of the remote peer GTP-U entities to the UP function 710 (e.g., UPF) is described with reference to steps 3 and 4 of the process 700 illustrated in FIG. 7.

Option 3: In some aspects, the CP function 708 (e.g., SMF) may provide the one or more source IP addresses of a remote peer GTP-U entity, which are used as the source IP address of GTP-U payload packets received for a given source Interface (e.g., “Access”, “Core”) that is supported by the UP function 710 (e.g., UPF). In some aspects, the CP function 708 may provide these one or more source IP addresses in the PFCP Association Establishment Setup or Update procedure and request the UP function 710 to accept the packets only from these one or more source IP addresses for a given source interface. This option for the CP function 708 to provide the source IP addresses of the remote peer GTP-U entities to the UP function 710 (e.g., UPF) is described with reference to steps 3 and 4 of the process 700 illustrated in FIG. 7.

Option 4: In some aspects, the CP function 708 (e.g., SMF) may provide the one or more source IP addresses of a remote peer GTP-U entity in the PFCP Association Establishment Setup procedure and request the UP function 710 (e.g., UPF) to accept packets only from these one or more source IP addresses. This option for the CP function 708 to provide the source IP addresses of the remote peer GTP-U entities to the UP function 710 (e.g., UPF) is described with reference to steps 3 and 4 of the process 700 illustrated in FIG. 7.

In some aspects, the Options 1-4 for the CP function 708 to provide the source IP addresses of the remote peer GTP-U entities to the UP function 710 (e.g., UPF) may rely on the control plane signaling via the CP function 708 to exchange the source IP addresses used in GTP-U entities. In some alternative aspects, GTP-U signaling may be used. That is, in some alternative aspects, as an alternative to using the control plane signaling among control plane and user plane entities for source addresses information delivery as describe above, a GTP-U entity may use GTP-U Echo Request or Echo Response message, or Tunnel Status Message between user plane entities directly to populate its one or more source IP addresses to be used to send GTP-U payload packets. In some aspects, the source IP address information may be sent encrypted (e.g., using a pre-configured key).

### 3. Flowcharts

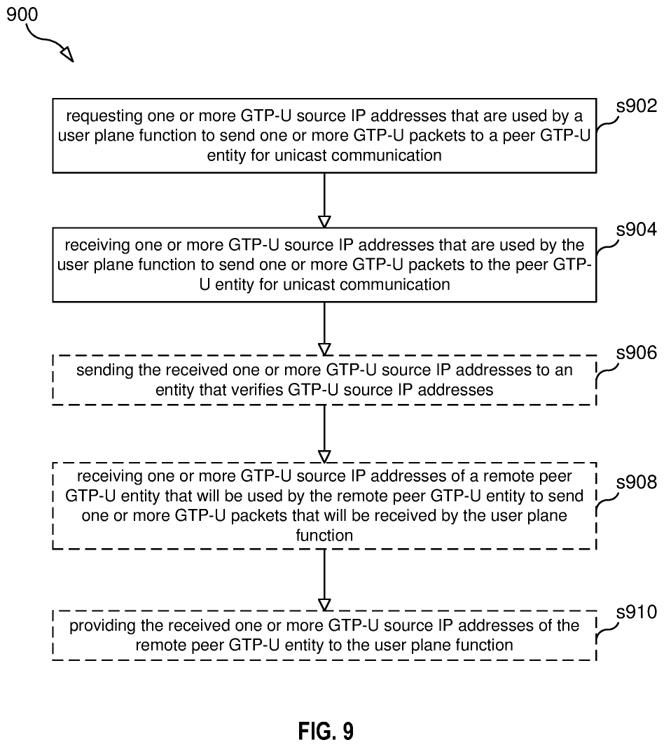

FIG. 9 is a flowchart illustrating a process 900 performed by a control plane function 708 (e.g., an SMF, an SGW-C, a PGW-C, a PGW/SGW-C, a PGW-C/SMF, or an MB-SMF) according to some aspects. In some aspects, the process 900 may include a step s902 in which the control plane function 708 requests one or more GTP-U source IP addresses that are used by a user plane function 710 (e.g., a UPF, an SGW-U, a PGW-U, a PGW/SGW-U, or an MB-UPF) to send one or more GTP-U packets to a peer GTP-U entity for unicast communication. In some aspects, the process 900 may include a s904 in which the control plane function 708 receives one or more GTP-U source IP addresses that are used by the user plane function 710 to send one or more GTP-U packets to the peer GTP-U entity for unicast communication.

In some aspects, requesting the one or more GTP-U source IP addresses in step s902 may include indicating in a Forwarding Action Rule (FAR) that the one or more GTP-U source IP addresses are requested, and the one or more GTP-U source IP addresses received in step s904 may indicate the one or more GTP-U source IP addresses that will be used for one or more GTP-U packets forwarded by the FAR. In some aspects, a packet forwarding control protocol (PFCP) session establishment request may include the indication that the one or more GTP-U source IP addresses are requested, and a PFCP session establishment response may include the one or more GTP-U source IP addresses. In some aspects, receiving the one or more GTP-U source IP addresses in step s904 may include receiving a Created FAR IE.

In some aspects, requesting the one or more GTP-U source IP addresses in step s902 may include indicating in a PFCP association establishment setup procedure that the one or more GTP-U source IP addresses are requested. In some aspects, requesting the one or more GTP-U source IP addresses may include indicating in a PFCP association setup request that the one or more GTP-U source IP addresses are requested, and a PFCP association setup response may include the one or more GTP-U source IP addresses. In some aspects, requesting the one or more GTP-U source IP addresses may include indicating that the request is for a network instance, a network slice, and/or a destination interface.

In some aspects, the received one or more GTP-U source IP addresses may be used by the user plane function 710 for a network instance and/or a network slice supported by the user plane function 710. In some aspects, the received one or more GTP-U source IP addresses may be used by the user plane function for a destination interface supported by the user plane function 710. In some aspects, the received one or more GTP-U source IP addresses may include all GTP-U source IP addresses that are used by the user plane function 710 to send one or more GTP-U packets.

In some aspects, receiving the one or more GTP-U source IP addresses in step s904 may include retrieving the one or more GTP-U source IP addresses from a Network Repository Function (NRF) 812. In some aspects, the one or more GTP-U source IP addresses received in step s904 may be included in a list of candidate user plane functions.

In some aspects, the process 900 may include an optional step s906 in which the control plane function 708 sends the received one or more GTP-U source IP addresses to an entity (e.g., a remote peer GTP-U entity or a network function 706 with a firewall function) that verifies GTP-U source IP addresses.

In some aspects, the process 900 may include an optional step s908 in which the control plane function 708 receives one or more GTP-U source IP addresses of a remote peer GTP-U entity that will be used by the remote peer GTP-U entity to send one or more GTP-U packets that will be received by the user plane function 710. In some aspects, the process 900 may include an optional step s910 in which the control plane function 708 provides the received one or more GTP-U source IP addresses of the remote peer GTP-U entity to the user plane function 710. In some aspects, the received one or more GTP-U source IP addresses of the remote peer GTP-U entity may be provided to the user plane function 710 in one or more packet detection rules (PDR) that are installed in the user plane function for a packet data network (PDN) connection and/or a protocol data unit (PDU) session.

In some aspects, the process 900 may include an optional step in which the control plane function 708 provides an indication to request the user plane function 710 to verify that a GTP-U source IP address of a GTP-U packet that will be received by the user plane function 710 matches a GTP-U source IP address of the one or more GTP-U source IP addresses of the remote peer GTP-U entity provided to the user plane function 710 in step s910. In some aspects, the process 900 may include an optional step in which the control plane function 708 provides the user plane function 710 with instructions for a GTP-U packet having a GTP-U source IP address that does not match any of the one or more GTP-U source IP addresses of the remote peer GTP-U entity provided to the user plane function 710 in step s910. In some aspects, the provided instructions may include (i) a request for the user plane function 710 to report to the control plane function 708 for a GTP-U packet having a GTP-U source IP address that does not match any of the one or more GTP-U source IP addresses of the remote peer GTP-U entity provided to the user plane function 710 and/or (ii) a request for the user plane function 710 to discard or accept GTP-U packets having a GTP-U source IP address that does not match any of the one or more GTP-U source IP addresses of the remote peer GTP-U entity provided to the user plane function 710.

In some aspects, the received one or more GTP-U source IP addresses of the remote peer GTP-U entity may be provided to the user plane function 710 in step s910 in a packet forwarding control protocol (PFCP) association establishment setup or update procedure.

In some aspects, the received one or more GTP-U source IP addresses of the remote peer GTP-U entity may be used by the remote peer GTP-U entity to send one or more GTP-U packets to a network instance and/or a network slice supported by the user plane function 710, and the process 900 may include the control plane function 708 requesting that the user plane function 710 accept only GTP-U packets from the received one or more GTP-U source IP addresses of the remote peer GTP-U entity for the network instance and/or the network slice. In some aspects, the received one or more GTP-U source IP addresses of the remote peer GTP-U entity may be used by the remote peer GTP-U entity to send one or more GTP-U packets to a source interface supported by the user plane function 710, and the process 900 may include the control plane function 708 requesting that the user plane function 710 accept only GTP-U packets from the received one or more GTP-U source IP addresses of the remote peer GTP-U entity for the source interface. In some aspects, the process 900 may include the control plane function 708 requesting that the user plane function 710 accept only GTP-U packets from the received one or more GTP-U source IP addresses of the remote peer GTP-U entity.

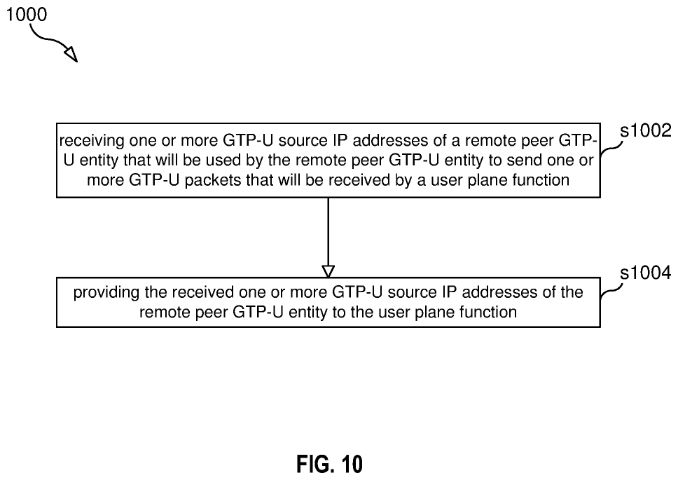

FIG. 10 is a flowchart illustrating a process 1000 performed by a control plane function 708 (e.g., an SMF, an SGW-C, a PGW-C, a PGW/SGW-C, a PGW-C/SMF, or an MB-SMF) according to some aspects. In some aspects, the process 1000 may include a step 402 (s1002) in which the control plane function 708 receives one or more GTP-U source IP addresses of a remote peer GTP-U entity that will be used by the remote peer GTP-U entity to send one or more GTP-U packets that will be received by a user plane function 710 (e.g., a UPF, an SGW-U, a PGW-U, a PGW/SGW-U, or an MB-UPF). In some aspects, the process 1000 may include a step 404 (s1004) in which the control plane function 708 provides the received one or more GTP-U source IP addresses of the remote peer GTP-U entity to the user plane function 710.

In some aspects, the one or more GTP-U source IP addresses of the remote peer GTP-U entity received in step 402 may be provided to the user plane function 710 in step 404 in one or more packet detection rules (PDR) that are installed in the user plane function 710 for a packet data network (PDN) connection and/or a protocol data unit (PDU) session. In some aspects, the process 1000 may further include the control plane function 708 providing an indication to request the user plane function 710 to verify that a GTP-U source IP address of a GTP-U packet that will be received by the user plane function 710 matches a GTP-U source IP address of the one or more GTP-U source IP addresses of the remote peer GTP-U entity provided to the user plane function in step 404. In some aspects, the process 1000 may include providing the user plane function 710 with instructions for a GTP-U packet having a GTP-U source IP address that does not match any of the one or more GTP-U source IP addresses of the remote peer GTP-U entity provided to the user plane function 710 in step 404.

In some aspects, the received one or more GTP-U source IP addresses of the remote peer GTP-U entity may be provided to the user plane function 710 in step 404 in a packet forwarding control protocol (PFCP) association establishment setup or update procedure. In some aspects, the received one or more GTP-U source IP addresses of the remote peer GTP-U entity may be used by the remote peer GTP-U entity to send one or more GTP-U packets to a network instance and/or a network slice supported by the user plane function 710, and the process 1000 may include the control plane function 708 requesting that the user plane function 710 accept only GTP-U packets from the received one or more GTP-U source IP addresses of the remote peer GTP-U entity for the network instance and/or the network slice. In some aspects, the received one or more GTP-U source IP addresses of the remote peer GTP-U entity may be used by the remote peer GTP-U entity to send one or more GTP-U packets to a source interface supported by the user plane function 710, and the process 1000 may include the control plane function 708 requesting that the user plane function 710 accept only GTP-U packets from the received one or more GTP-U source IP addresses of the remote peer GTP-U entity for the source interface. In some aspects, the process 1000 may further include requesting that the user plane function accept only GTP-U packets from the received one or more GTP-U source IP addresses of the remote peer GTP-U entity.

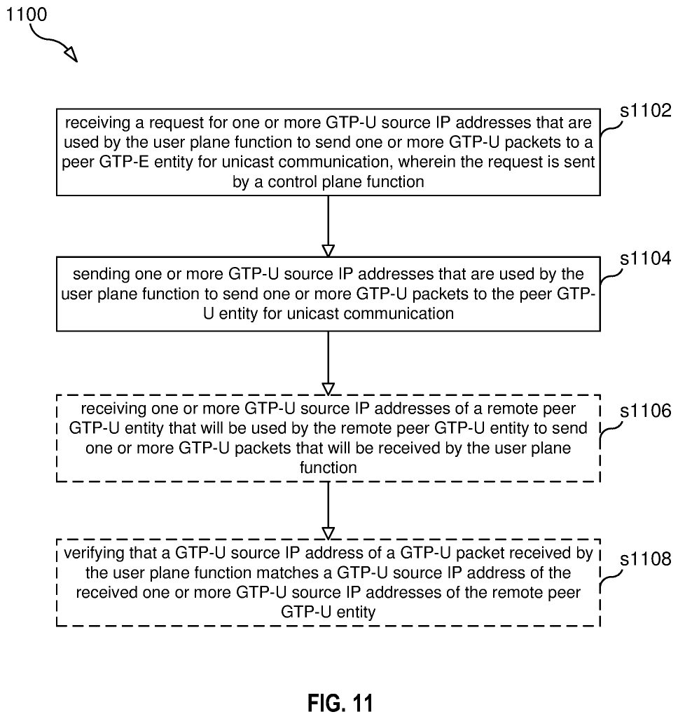

FIG. 11 is a flowchart illustrating a process 1100 performed by a user plane function 710 (e.g., a UPF, an SGW-U, a PGW-U, a PGW/SGW-U, or an MB-UPF) according to some aspects. In some aspects, the process 1100 may include a step 502 (s1102) in which the user plane function 710 receives a request for one or more GTP-U source IP addresses that are used by the user plane function 710 to send one or more GTP-U packets to a peer GTP-E entity for unicast communication. In some aspects, the request received in step 502 may be sent by a control plane function 708 (e.g., an SMF, an SGW-C, a PGW-C, a PGW/SGW-C, a PGW-C/SMF, or an MB-SMF). In some aspects, the process 1100 may include a step 504 (s1104) in which the user plane function 710 sends one or more GTP-U source IP addresses that are used by the user plane function 710 to send one or more GTP-U packets to the peer GTP-U entity for unicast communication.

In some aspects, the request for the one or more GTP-U source IP addresses received in step 502 may include an indication in a Forwarding Action Rule (FAR) that the one or more GTP-U source IP addresses are requested, and the one or more GTP-U source IP addresses sent in step 504 may indicate the one or more GTP-U source IP addresses that will be used for one or more GTP-U packets forwarded by the FAR. In some aspects, a packet forwarding control protocol (PFCP) session establishment request may include the indication that the one or more GTP-U source IP addresses are requested, and a PFCP session establishment response may include the one or more GTP-U source IP addresses. In some aspects, sending the one or more GTP-U source IP addresses in step 504 may include sending a Created FAR IE.

In some aspects, the request for the one or more GTP-U source IP addresses received in step 502 may include an indication in a packet forwarding control protocol (PFCP) association establishment setup procedure that the one or more GTP-U source IP addresses are requested. In some aspects, the request for the one or more GTP-U source IP addresses received in step 502 may include an indication in a PFCP association setup request that the one or more GTP-U source IP addresses are requested, and a PFCP association setup response may include the one or more GTP-U source IP addresses. In some aspects, the request for the one or more GTP-U source IP addresses received in step 502 may include an indication that the request is for a network instance, a network slice, and/or a destination interface.

In some aspects, the one or more GTP-U source IP addresses sent in step 504 may be used by the user plane function 710 for a network instance and/or a network slice supported by the user plane function 710. In some aspects, the one or more GTP-U source IP addresses sent in step 504 may be used by the user plane function 710 for a destination interface supported by the user plane function 710. In some aspects, the one or more GTP-U source IP addresses sent in step 504 may include all GTP-U source IP addresses that are used by the user plane function 710 to send one or more GTP-U packets.

In some aspects, the process 1100 may include an optional step 506 (s1106) in which the user plane function 710 receives one or more GTP-U source IP addresses of a remote peer GTP-U entity that will be used by the remote peer GTP-U entity to send one or more GTP-U packets that will be received by the user plane function 710. In some aspects, the one or more GTP-U source IP addresses of the remote peer GTP-U entity may be received by the user plane function 710 in one or more packet detection rules (PDR) that are installed in the user plane function for a packet data network (PDN) connection and/or a protocol data unit (PDU) session.

In some aspects, the process 1100 may include an optional step 508 (s1108) in which the user plane function 710 verifies that a GTP-U source IP address of a GTP-U packet received by the user plane function 710 matches a GTP-U source IP address of the one or more GTP-U source IP addresses of the remote peer GTP-U entity received in step 506. In some aspects, the process 1100 may include the user plane function 710 receiving instructions for a GTP-U packet having a GTP-U source IP address that does not match any of the one or more GTP-U source IP addresses of the remote peer GTP-U entity received in step 506. In some aspects, the received instructions may include (i) a request for the user plane function 710 to report to the control plane function 708 for a GTP-U packet having a GTP-U source IP address that does not match any of the one or more GTP-U source IP addresses of the remote peer GTP-U entity provided to the user plane function 710 in step 506 and/or (ii) a request for the user plane function 710 to discard or accept GTP-U packets having a GTP-U source IP address that does not match any of the one or more GTP-U source IP addresses of the remote peer GTP-U entity provided to the user plane function 710 in step 506.

In some aspects, the one or more GTP-U source IP addresses of the remote peer GTP-U entity may be received by the user plane function 710 in step 506 in a packet forwarding control protocol (PFCP) association establishment setup or update procedure. In some aspects, the received one or more GTP-U source IP addresses of the remote peer GTP-U entity may be used by the remote peer GTP-U entity to send one or more GTP-U packets to a network instance and/or a network slice supported by the user plane function 710, and the process 1100 may include the user plane function 710 accepting only GTP-U packets from the received one or more GTP-U source IP addresses of the remote peer GTP-U entity for the network instance and/or the network slice. In some aspects, the received one or more GTP-U source IP addresses of the remote peer GTP-U entity may be used by the remote peer GTP-U entity to send one or more GTP-U packets to a source interface supported by the user plane function 710, and the process 1100 may include the user plane function 710 accepting only GTP-U packets from the received one or more GTP-U source IP addresses of the remote peer GTP-U entity for the source interface. In some aspects, the process 1100 may include accepting only GTP-U packets from the received one or more GTP-U source IP addresses of the remote peer GTP-U entity.

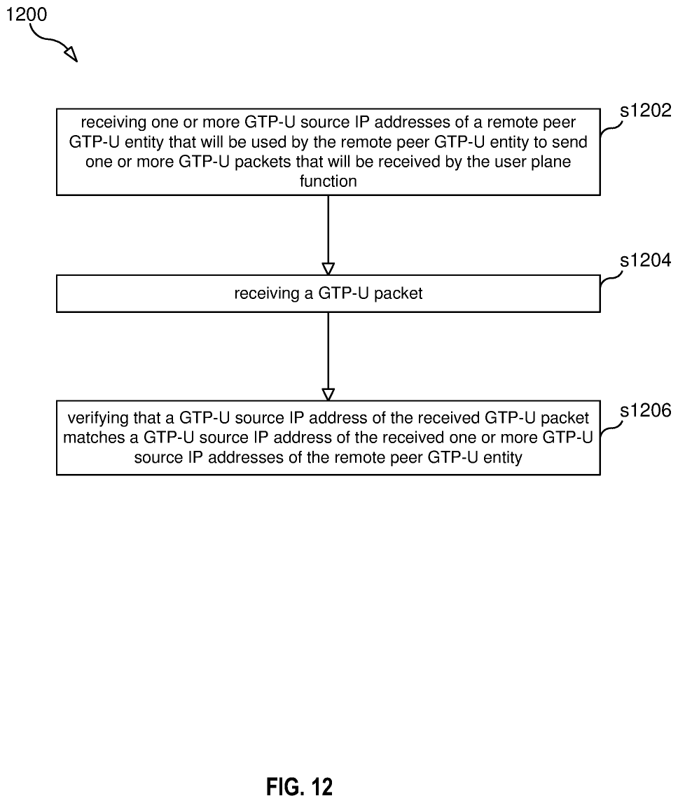

FIG. 12 is a flowchart illustrating a process 1200 performed by a user plane function 710 (e.g., a UPF, an SGW-U, a PGW-U, a PGW/SGW-U, or an MB-UPF) according to some aspects. In some aspects, the process 1200 may include a step 602 (s1202) in which the user plane function 710 receives one or more GTP-U source IP addresses of a remote peer GTP-U entity that will be used by the remote peer GTP-U entity to send one or more GTP-U packets that will be received by the user plane function 710. In some aspects, the process 1200 may include a step 604 (s1204) in which the user plane function 710 receives a GTP-U packet. In some aspects, the process 1200 may include a step 606 (s1206) in which the user plane function 710 verifies that a GTP-U source IP address of the GTP-U packet received in step 604 matches a GTP-U source IP address of the one or more GTP-U source IP addresses of the remote peer GTP-U entity received in step 602.

In some aspects, the process 1200 may include the user plane function 710 discarding a received GTP-U packets that has a source IP address that does not match any of the received one or more GTP-U source IP addresses of the remote peer GTP-U entity. In some aspects, the process 1200 may include the user plane function 710 forwarding a received GTP-U packets that has a source IP address that does not match any of the received one or more GTP-U source IP addresses of the remote peer GTP-U entity. In some aspects, the process 1200 may include the user plane function 710 reporting to the control plane function 708 that the user plane function 710 has received a GTP-U packet having a source IP address that does not match any of the received one or more GTP-U source IP addresses of the remote peer GTP-U entity.

In some aspects, the one or more GTP-U source IP addresses received in step 602 may be included in one or more packet detection rules (PDR) that are installed in the user plane function 710 for a packet data network (PDN) connection and/or a protocol data unit (PDU) session. In some aspects, the process 1200 may include the user plane function 710 receiving instructions for a GTP-U packet having a GTP-U source IP address that does not match any of the one or more GTP-U source IP addresses of the remote peer GTP-U entity provided to the user plane function 710 in step 602.

In some aspects, the one or more GTP-U source IP addresses of the remote peer GTP-U entity may be received in step 602 in a packet forwarding control protocol (PFCP) association establishment setup or update procedure. In some aspects, the received one or more GTP-U source IP addresses of the remote peer GTP-U entity may be used by the remote peer GTP-U entity to send one or more GTP-U packets to a network instance and/or a network slice supported by the user plane function, and the process 1200 may include the user plane function 710 accepting only GTP-U packets from the received one or more GTP-U source IP addresses of the remote peer GTP-U entity for the network instance and/or the network slice. In some aspects, the received one or more GTP-U source IP addresses of the remote peer GTP-U entity may be used by the remote peer GTP-U entity to send one or more GTP-U packets to a source interface supported by the user plane function 710, and the process 1200 may include the user plane function 710 accepting only GTP-U packets from the received one or more GTP-U source IP addresses of the remote peer GTP-U entity for the source interface. In some aspects, the process 1200 may include the user plane function 710 accepting only GTP-U packets from the received one or more GTP-U source IP addresses of the remote peer GTP-U entity.

In some aspects, the one or more GTP-U source IP addresses of the remote peer GTP-U entity received in step 602 may have been sent by a control plane function 708 (e.g., an SMF, an SGW-C, a PGW-C, a PGW/SGW-C, a PGW-C/SMF, or an MB-SMF).

In some aspects, the one or more GTP-U source IP addresses of the remote peer GTP-U entity received in step 602 may have been sent by the remote peer GTP-U entity. In some aspects, the received one or more GTP-U source IP addresses of the remote peer GTP-U entity may have been sent by the remote peer GTP-U entity using an GTP-U Echo Request message, an Echo Response message, or a Tunnel Status Message. In some aspects, the received one or more GTP-U source IP addresses of the remote peer GTP-U entity may be encrypted (e.g., using a pre-configured key).

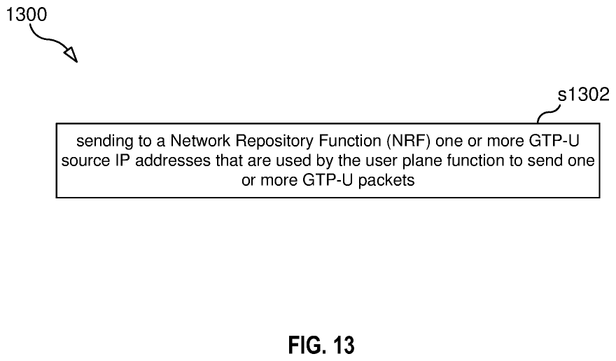

FIG. 13 is a flowchart illustrating a process 1300 performed by a user plane function 710 (e.g., a UPF, an SGW-U, a PGW-U, a PGW/SGW-U, or an MB-UPF) according to some aspects. In some aspects, the process 1300 may include a step s1302 in which the user plane function 710 sends to a Network Repository Function (NRF) 812 one or more GTP-U source Internet Protocol (IP) addresses that are used by the user plane function 710 to send one or more GTP-U packets.

### Additional Embodiments

A1. A method (900) performed by a control plane function (708) (e.g., a session management function (SMF), a serving gateway (SGW) control plane function (SGW-C), a packet gateway (PGW) control plane function (PGW-C), a PGW/SGW-C, a PGW-C/SMF, or a multicast broadcast (MB) SMF (MB-SMF), the method comprising: requesting (s902) one or more General Packet Radio System, GPRS, Tunneling Protocol User Plane, GTP-U, source Internet Protocol, IP, addresses that are used by a user plane function (710) (e.g., a user plane function (UPF), an SGW user plane function (SGW-U), a PGW user plane function (PGW-U), a PGW/SGW-U, or an MB-UPF) to send one or more GTP-U packets to a peer GTP-U entity for unicast communication; and receiving (s904) one or more GTP-U source IP addresses that are used by the user plane function to send one or more GTP-U packets to the peer GTP-U entity for unicast communication.

A2. The method of embodiment A1, wherein requesting the one or more GTP-U source IP addresses comprises indicating in a Forwarding Action Rule (FAR) that the one or more GTP-U source IP addresses are requested, and the received one or more GTP-U source IP addresses indicate the one or more GTP-U source IP addresses that will be used for one or more GTP-U packets forwarded by the FAR.

A3. The method of embodiment A2, wherein a packet forwarding control protocol (PFCP) session establishment request includes the indication that the one or more GTP-U source IP addresses are requested, and a PFCP session establishment response includes the one or more GTP-U source IP addresses.

A4. The method of any one of embodiments A1-A3, wherein receiving the one or more GTP-U source IP addresses comprises receiving a Created FAR information element (IE).

A5. The method of embodiment A1, wherein requesting the one or more GTP-U source IP addresses comprises indicating in a packet forwarding control protocol (PFCP) association establishment setup procedure that the one or more GTP-U source IP addresses are requested.

A6a. The method of embodiment A5, wherein requesting the one or more GTP-U source IP addresses comprises indicating in a PFCP association setup request that the one or more GTP-U source IP addresses are requested, and a PFCP association setup response includes the one or more GTP-U source IP addresses.

A6b. The method of embodiment A5 or A6a, wherein requesting the one or more GTP-U source IP addresses comprises indicating that the request is for a network instance, a network slice, and/or a destination interface.

A7. The method of any one of embodiments A5-A6b, wherein the received one or more GTP-U source IP addresses are used by the user plane function for a network instance and/or a network slice supported by the user plane function.

A8. The method of any one of embodiments A5-A6b, wherein the received one or more GTP-U source IP addresses are used by the user plane function for a destination interface supported by the user plane function.

A9. The method of any one of embodiments A5-A6b, wherein the received one or more GTP-U source IP addresses include all GTP-U source IP addresses that are used by the user plane function to send one or more GTP-U packets.

A10. The method of embodiment A1, wherein receiving the one or more GTP-U source IP addresses comprises retrieving the one or more GTP-U source IP addresses from a Network Repository Function (NRF) (812).

A11. The method of embodiment A10, wherein the received one or more GTP-U source IP addresses are included in a list of candidate user plane functions.

A12. The method of any one of embodiments A1-A11, further comprising sending (s906) the received one or more GTP-U source IP addresses to an entity (e.g., a remote peer GTP-U entity or a network function (706) with a firewall function) that verifies GTP-U source IP addresses.

A13. The method of any one embodiments A1-A12, further comprising receiving (s908) one or more GTP-U source IP addresses of a remote peer GTP-U entity that will be used by the remote peer GTP-U entity to send one or more GTP-U packets that will be received by the user plane function.

A14. The method of embodiment A13, further comprising providing (s910) the received one or more GTP-U source IP addresses of the remote peer GTP-U entity to the user plane function.

A15. The method of embodiment A14, wherein the received one or more GTP-U source IP addresses of the remote peer GTP-U entity are provided to the user plane function in one or more packet detection rules (PDR) that are installed in the user plane function for a packet data network (PDN) connection and/or a protocol data unit (PDU) session.

A16. The method of embodiment A14 or A15, further comprising providing an indication to request the user plane function to verify that a GTP-U source IP address of a GTP-U packet that will be received by the user plane function matches a GTP-U source IP address of the one or more GTP-U source IP addresses of the remote peer GTP-U entity provided to the user plane function.

A17a. The method of embodiment A16, further comprising providing the user plane function with instructions for a GTP-U packet having a GTP-U source IP address that does not match any of the one or more GTP-U source IP addresses of the remote peer GTP-U entity provided to the user plane function.

A17b. The method of embodiment A17a, wherein the provided instructions comprise (i) a request for the user plane function to report to the control plane function for a GTP-U packet having a GTP-U source IP address that does not match any of the one or more GTP-U source IP addresses of the remote peer GTP-U entity provided to the user plane function and/or (ii) a request for the user plane function to discard or accept GTP-U packets having a GTP-U source IP address that does not match any of the one or more GTP-U source IP addresses of the remote peer GTP-U entity provided to the user plane function.

A18. The method of embodiment A14, wherein the received one or more GTP-U source IP addresses of the remote peer GTP-U entity are provided to the user plane function in a packet forwarding control protocol (PFCP) association establishment setup or update procedure.

A19. The method of embodiment A14 or A18, wherein the received one or more GTP-U source IP addresses of the remote peer GTP-U entity will be used by the remote peer GTP-U entity to send one or more GTP-U packets to a network instance and/or a network slice supported by the user plane function, and the method further comprises requesting that the user plane function accept only GTP-U packets from the received one or more GTP-U source IP addresses of the remote peer GTP-U entity for the network instance and/or the network slice.

A20. The method of embodiment A14 or A18, wherein the received one or more GTP-U source IP addresses of the remote peer GTP-U entity will be used by the remote peer GTP-U entity to send one or more GTP-U packets to a source interface supported by the user plane function, and the method further comprises requesting that the user plane function accept only GTP-U packets from the received one or more GTP-U source IP addresses of the remote peer GTP-U entity for the source interface.

A21. The method of embodiment A14 or A18, further comprising requesting that the user plane function accept only GTP-U packets from the received one or more GTP-U source IP addresses of the remote peer GTP-U entity.

B1. A control plane function (708) (e.g., a session management function (SMF), a serving gateway (SGW) control plane function (SGW-C), a packet gateway (PGW) control plane function (PGW-C), a PGW/SGW-C, a PGW-C/SMF, or a multicast broadcast (MB) SMF (MB-SMF)) configured to: request one or more General Packet Radio System, GPRS, Tunneling Protocol User Plane, GTP-U, source Internet Protocol, IP, addresses that are used by a user plane function (710) (e.g., a user plane function (UPF), an SGW user plane function (SGW-U), a PGW user plane function (PGW-U), a PGW/SGW-U, or an MB-UPF) to send one or more GTP-U packets to a peer GTP-U entity for unicast communication; and receive one or more GTP-U source IP addresses that are used by the user plane function to send one or more GTP-U packets to the peer GTP-U entity for unicast communication.

B2. The control plane function of B1, further configured to perform the method of any one of embodiments A2-A21.

C1. A method (1000) performed by a control plane function (708) (e.g., a session management function (SMF), a serving gateway (SGW) control plane function (SGW-C), a packet gateway (PGW) control plane function (PGW-C), a PGW/SGW-C, a PGW-C/SMF, or a multicast broadcast (MB) SMF (MB-SMF)), the method comprising: receiving (s1002) one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by a user plane function (710) (e.g., a user plane function (UPF), an SGW user plane function (SGW-U), a PGW user plane function (PGW-U), a PGW/SGW-U, or an MB-UPF); and providing (s1004) the received one or more GTP-U source IP addresses of the remote peer GTP-U entity to the user plane function.

C2. The method of embodiment C1, wherein the received one or more GTP-U source IP addresses of the remote peer GTP-U entity are provided to the user plane function in one or more packet detection rules (PDR) that are installed in the user plane function for a packet data network (PDN) connection and/or a protocol data unit (PDU) session.

C3. The method of embodiment C1 or C2, further comprising providing an indication to request the user plane function to verify that a GTP-U source IP address of a GTP-U packet that will be received by the user plane function matches a GTP-U source IP address of the one or more GTP-U source IP addresses of the remote peer GTP-U entity provided to the user plane function.

C4. The method of embodiment C3, further comprising providing the user plane function with instructions for a GTP-U packet having a GTP-U source IP address that does not match any of the one or more GTP-U source IP addresses of the remote peer GTP-U entity provided to the user plane function.

C5. The method of embodiment C1, wherein the received one or more GTP-U source IP addresses of the remote peer GTP-U entity are provided to the user plane function in a packet forwarding control protocol (PFCP) association establishment setup or update procedure.

C6. The method of embodiment C1 or C5, wherein the received one or more GTP-U source IP addresses of the remote peer GTP-U entity will be used by the remote peer GTP-U entity to send one or more GTP-U packets to a network instance and/or a network slice supported by the user plane function, and the method further comprises requesting that the user plane function accept only GTP-U packets from the received one or more GTP-U source IP addresses of the remote peer GTP-U entity for the network instance and/or the network slice.

C7. The method of embodiment C1 or C5, wherein the received one or more GTP-U source IP addresses of the remote peer GTP-U entity will be used by the remote peer GTP-U entity to send one or more GTP-U packets to a source interface supported by the user plane function, and the method further comprises requesting that the user plane function accept only GTP-U packets from the received one or more GTP-U source IP addresses of the remote peer GTP-U entity for the source interface.

C8. The method of embodiment C1 or C5, further comprising requesting that the user plane function accept only GTP-U packets from the received one or more GTP-U source IP addresses of the remote peer GTP-U entity.

D1. A control plane function (708) (e.g., a session management function (SMF), a serving gateway (SGW) control plane function (SGW-C), a packet gateway (PGW) control plane function (PGW-C), a PGW/SGW-C, a PGW-C/SMF, or a multicast broadcast (MB) SMF (MB-SMF) configured to: receive one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by a user plane function (710) (e.g., a user plane function (UPF), an SGW user plane function (SGW-U), a PGW user plane function (PGW-U), a PGW/SGW-U, or an MB-UPF); and provide the received one or more GTP-U source IP addresses of the remote peer GTP-U entity to the user plane function.

D2. The control plane function of D1, further configured to perform the method of any one of embodiments C2-C8.

E1. A method (1100) performed by a user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)), the method comprising: receiving (s1102) a request for one or more General Packet Radio System, GPRS, Tunneling Protocol User Plane, GTP-U, source Internet Protocol, IP, addresses that are used by the user plane function to send one or more GTP-U packets to a peer GTP-E entity for unicast communication, wherein the request is sent by a control plane function (708) (e.g., a session management function (SMF), an SGW control plane function (SGW-C), a PGW control plane function (PGW-C), a PGW/SGW-C, a PGW-C/SMF, or an MB-SMF); and sending (s1104) one or more GTP-U source IP addresses that are used by the user plane function to send one or more GTP-U packets to the peer GTP-U entity for unicast communication.

E2. The method of embodiment E1, wherein the request for the one or more GTP-U source IP addresses comprises an indication in a Forwarding Action Rule (FAR) that the one or more GTP-U source IP addresses are requested, and the sent one or more GTP-U source IP addresses indicate the one or more GTP-U source IP addresses that will be used for one or more GTP-U packets forwarded by the FAR.

E3. The method of embodiment E2, wherein a packet forwarding control protocol (PFCP) session establishment request includes the indication that the one or more GTP-U source IP addresses are requested, and a PFCP session establishment response includes the one or more GTP-U source IP addresses.

E4. The method of any one of embodiments E1-E3, wherein sending the one or more GTP-U source IP addresses comprises sending a Created FAR information element (IE).

E5. The method of embodiment E1, wherein the request for the one or more GTP-U source IP addresses comprises an indication in a packet forwarding control protocol (PFCP) association establishment setup procedure that the one or more GTP-U source IP addresses are requested.

E6a. The method of embodiment E5, wherein the request for the one or more GTP-U source IP addresses comprises an indication in a PFCP association setup request that the one or more GTP-U source IP addresses are requested, and a PFCP association setup response includes the one or more GTP-U source IP addresses.

E6b. The method of embodiment E5 or E6a, wherein the request for the one or more GTP-U source IP addresses comprises an indication that the request is for a network instance, a network slice, and/or a destination interface.

E7. The method of any one of embodiments E5-E6b, wherein the sent one or more GTP-U source IP addresses are used by the user plane function for a network instance and/or a network slice supported by the user plane function.

E8. The method of any one of embodiments E5-E6b, wherein the sent one or more GTP-U source IP addresses are used by the user plane function for a destination interface supported by the user plane function.

E9. The method of any one of embodiments E5-E6b, wherein the sent one or more GTP-U source IP addresses include all GTP-U source IP addresses that are used by the user plane function to send one or more GTP-U packets.

E10. The method of any one embodiments E1-E9, further comprising receiving (s1106) one or more GTP-U source IP addresses of a remote peer GTP-U entity that will be used by the remote peer GTP-U entity to send one or more GTP-U packets that will be received by the user plane function.

E11. The method of embodiment E10, wherein the one or more GTP-U source IP addresses of the remote peer GTP-U entity are received by the user plane function in one or more packet detection rules (PDR) that are installed in the user plane function for a packet data network (PDN) connection and/or a protocol data unit (PDU) session.

E12. The method of embodiment E10 or E11, further comprising verifying (s1108) that a GTP-U source IP address of a GTP-U packet received by the user plane function matches a GTP-U source IP address of the received one or more GTP-U source IP addresses of the remote peer GTP-U entity.

E13a. The method of embodiment E12, further comprising receiving instructions for a GTP-U packet having a GTP-U source IP address that does not match any of the received one or more GTP-U source IP addresses of the remote peer GTP-U entity.

E13b. The method of embodiment E13a, wherein the received instructions comprise (i) a request for the user plane function to report to the control plane function for a GTP-U packet having a GTP-U source IP address that does not match any of the one or more GTP-U source IP addresses of the remote peer GTP-U entity provided to the user plane function and/or (ii) a request for the user plane function to discard or accept GTP-U packets having a GTP-U source IP address that does not match any of the one or more GTP-U source IP addresses of the remote peer GTP-U entity provided to the user plane function.

E14. The method of embodiment E10, wherein the one or more GTP-U source IP addresses of the remote peer GTP-U entity are received by the user plane function in a packet forwarding control protocol (PFCP) association establishment setup or update procedure.

E15. The method of embodiment E10 or E14, wherein the received one or more GTP-U source IP addresses of the remote peer GTP-U entity will be used by the remote peer GTP-U entity to send one or more GTP-U packets to a network instance and/or a network slice supported by the user plane function, and the method further comprises accepting only GTP-U packets from the received one or more GTP-U source IP addresses of the remote peer GTP-U entity for the network instance and/or the network slice.

E16. The method of embodiment E10 or E14, wherein the received one or more GTP-U source IP addresses of the remote peer GTP-U entity will be used by the remote peer GTP-U entity to send one or more GTP-U packets to a source interface supported by the user plane function, and the method further comprises accepting only GTP-U packets from the received one or more GTP-U source IP addresses of the remote peer GTP-U entity for the source interface.

E17. The method of embodiment E10 or E14, further comprising accepting only GTP-U packets from the received one or more GTP-U source IP addresses of the remote peer GTP-U entity.

F1. A user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)) configured to: receive a request for one or more General Packet Radio System, GPRS, Tunneling Protocol User Plane, GTP-U, source Internet Protocol, IP, addresses that are used by the user plane function to send one or more GTP-U packets to a peer GTP-E entity for unicast communication, wherein the request is sent by a control plane function (708) (e.g., a session management function (SMF), an SGW control plane function (SGW-C), a PGW control plane function (PGW-C), a PGW/SGW-C, a PGW-C/SMF, or an MB-SMF); and send one or more GTP-U source IP addresses that are used by the user plane function to send one or more GTP-U packets to the peer GTP-U entity for unicast communication.

F2. The user plane function of F1, further configured to perform the method of any one of embodiments E2-E17.

G1. A method (1200) performed by a user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)), the method comprising: receiving (s1202) one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by the user plane function; receiving (s1204) a GTP-U packet; and verifying (s1206) that a GTP-U source IP address of the received GTP-U packet matches a GTP-U source IP address of the received one or more GTP-U source IP addresses of the remote peer GTP-U entity.

G2a. The method of embodiment G1, further comprising discarding a received GTP-U packets that has a source IP address that does not match any of the received one or more GTP-U source IP addresses of the remote peer GTP-U entity.

G2b. The method of embodiment G1 or G2a, further comprising forwarding a received GTP-U packets that has a source IP address that does not match any of the received one or more GTP-U source IP addresses of the remote peer GTP-U entity.

G2c. The method of any one of embodiments G1-G2b, further comprising reporting to the control plane function that the user plane function has received a GTP-U packet having a source IP address that does not match any of the received one or more GTP-U source IP addresses of the remote peer GTP-U entity.

G2d. The method of any one of embodiments G1-G2c, wherein the received one or more GTP-U source IP addresses are included in one or more packet detection rules (PDR) that are installed in the user plane function for a packet data network (PDN) connection and/or a protocol data unit (PDU) session.

G3. The method of any one of embodiments G1-G2d, further comprising receiving instructions for a GTP-U packet having a GTP-U source IP address that does not match any of the one or more GTP-U source IP addresses of the remote peer GTP-U entity provided to the user plane function.

G4. The method of any one of embodiments G1-G2c, wherein the one or more GTP-U source IP addresses of the remote peer GTP-U entity are received in a packet forwarding control protocol (PFCP) association establishment setup or update procedure.

G5. The method of any one of embodiments G1-G2c and G4, wherein the received one or more GTP-U source IP addresses of the remote peer GTP-U entity will be used by the remote peer GTP-U entity to send one or more GTP-U packets to a network instance and/or a network slice supported by the user plane function, and the method further comprises accepting only GTP-U packets from the received one or more GTP-U source IP addresses of the remote peer GTP-U entity for the network instance and/or the network slice.

G6. The method of any one of embodiments G1-G2c and G4, wherein the received one or more GTP-U source IP addresses of the remote peer GTP-U entity will be used by the remote peer GTP-U entity to send one or more GTP-U packets to a source interface supported by the user plane function, and the method further comprises accepting only GTP-U packets from the received one or more GTP-U source IP addresses of the remote peer GTP-U entity for the source interface.

G7. The method of any one of embodiments G1-G2c and G4, further comprising accepting only GTP-U packets from the received one or more GTP-U source IP addresses of the remote peer GTP-U entity.

G8. The method of any one of embodiments G1-G7, wherein the received one or more GTP-U source IP addresses of the remote peer GTP-U entity were sent by a control plane function (708) (e.g., a session management function (SMF), an SGW control plane function (SGW-C), a PGW control plane function (PGW-C), a PGW/SGW-C, a PGW-C/SMF, or an MB-SMF).

G9. The method of any one of embodiments G1-G2c, wherein the received one or more GTP-U source IP addresses of the remote peer GTP-U entity were sent by the remote peer GTP-U entity.

G10. The method of embodiment G9, wherein the received one or more GTP-U source IP addresses of the remote peer GTP-U entity were sent by the remote peer GTP-U entity using an GTP-U Echo Request message, an Echo Response message, or a Tunnel Status Message.

G11. The method of embodiment G9 or G10, wherein the received one or more GTP-U source IP addresses of the remote peer GTP-U entity were encrypted (e.g., using a pre-configured key).

H1. A user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)) configured to: receive one or more General Packet Radio System, GPRS, Tunneling Protocol User Plane, GTP-U, source Internet Protocol, IP, addresses of a remote peer GTP-U entity that will be used by the remote peer GTP-U entity to send one or more GTP-U packets that will be received by the user plane function; receive a GTP-U packet; and verify that a GTP-U source IP address of the received GTP-U packet matches a GTP-U source IP address of the received one or more GTP-U source IP addresses of the remote peer GTP-U entity.

H2. The user plane function of G1, further configured to perform the method of any one of embodiments G2a-G11.

I1. A method (1300) performed by a user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)), the method comprising: sending to a Network Repository Function (NRF) (812) one or more General Packet Radio System, GPRS, Tunneling Protocol User Plane, GTP-U, source Internet Protocol, IP, addresses that are used by the user plane function to send one or more GTP-U packets.

J1. A user plane function (710) (e.g., a user plane function (UPF), a serving gateway (SGW) user plane function (SGW-U), a packet gateway (PGW) user plane function (PGW-U), a PGW/SGW-U, or a multicast broadcast (MB) UPF (MB-UPF)) configured to send to a Network Repository Function (NRF) (812) one or more General Packet Radio System, GPRS, Tunneling Protocol User Plane, GTP-U, source Internet Protocol, IP, addresses that are used by the user plane function to send one or more GTP-U packets.

K1. A computer program (1443) comprising instructions (1444) which, when executed by processing circuitry (1402) of a network function (708, 710), cause the network function to perform the method of any one of embodiments A1-A21, C1-C8, E1-E17, G1-G11, or 11.

K2. A carrier containing the computer program of embodiment K1, wherein the carrier is one of an electronic signal, an optical signal, a radio signal, and a computer readable storage medium (842).

L1. A network function (708, 710) (e.g., control plane function or user plane function), the network function comprising: processing circuitry (1402); and a memory (1442), the memory containing instructions (1444) executable by the processing circuitry, whereby the network node is configured to perform the method of any one of the embodiments A1-A21, C1-C8, E1-E17, G1-G11, or 11.

M1. Any combination of the embodiments set forth above.

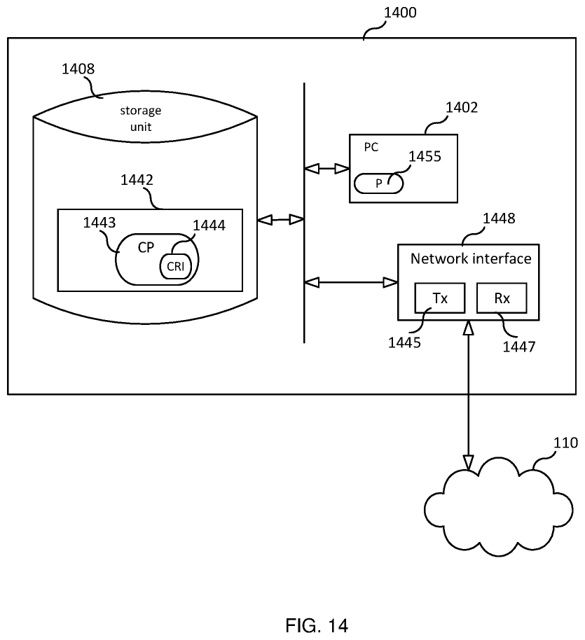

FIG. 14 is a block diagram of network node 1400, according to some embodiments, that can implement any one or more of the network functions described herein. That is, network node 1400 can perform the above described network function methods. As shown in FIG. 14, network node 1400 may comprise: processing circuitry (PC) 1402, which may include one or more processors (P) 1455 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., network node 1400 may be a distributed computing apparatus); at least one network interface 1448 comprising a transmitter (Tx) 1445 and a receiver (Rx) 1447 for enabling network node 1400 to transmit data to and receive data from other nodes connected to a network 110 (e.g., an Internet Protocol (IP) network) to which network interface 1448 is connected (directly or indirectly) (e.g., network interface 1448 may be wirelessly connected to the network 110, in which case network interface 1448 is connected to an antenna arrangement); and a storage unit (a.k.a., “data storage system”) 1408, which may include one or more non-volatile storage devices and/or one or more volatile storage devices. In embodiments where PC 1402 includes a programmable processor, a computer readable medium (CRM) 1442 may be provided. Computer readable medium (CRM) 1442 stores a computer program (CP) 1443 comprising computer readable instructions (CRI) 1444. CRM 1442 may be a non-transitory computer readable medium, such as, magnetic media (e.g., a hard disk), optical media, memory devices (e.g., random access memory, flash memory), and the like. In some embodiments, the CRI 1444 of computer program 1443 is configured such that when executed by PC 1402, the CRI causes network node 1400 to perform steps described herein (e.g., steps described herein with reference to the flow charts). In other embodiments, network node 1400 may be configured to perform steps described herein without the need for code. That is, for example, PC 1402 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method performed by a first network function, the method comprising:
receiving a handover related message related to a handover of a user equipment, UE, from a source radio access network, RAN, node to a target RAN node;
after receiving the handover related message, transmitting to a second network function a request message for establishing a forwarding tunnel;
receiving a response message transmitted by the second network function, wherein the response message is responsive to the request message for establishing a forwarding tunnel, and further wherein the response message comprises an address that the second network function will use as a source address when forwarding packets for the UE via the established forwarding tunnel to the target RAN node; and
after receiving the response message, transmitting a message comprising the source address, wherein the message is transmitted to: i) the target RAN node or ii) a third network function that is configured to transmit the source address to the target RAN node.

2. The method of claim 1, wherein
the message comprising the source address is a Handover Request (HR),
the Handover Request is transmitted to the target RAN node, and
the second network function obtained the address from a user plane function.

3. The method of claim 1, wherein
the message comprising the source address is an S1 control plane (S1-CP) message, and
the S1-CP message is transmitted to the target RAN node.

4. The method of claim 3, wherein the S1-CP message is an E-RAB Modify Request.

5. The method of claim 3, further comprising:
after receiving the handover related message and prior to transmitting to the target RAN node the S1-CP message comprising the source address, transmitting to the target RAN node a Handover Request.

6. The method of claim 1, wherein the request message for establishing the forwarding tunnel is a Create Indirect Data Forwarding Tunnel Request.

7. The method of claim 1, wherein the handover related message is:
a Handover Required message, or
a Forward Relocation Request.

8. The method of claim 1, wherein
the first network function is a Long Term Evolution, LTE, (LTE) Mobility Management Entity (MME), and
the second network function is an LTE Serving Gateway (SGW).

9. (canceled)

10. The method of claim 1, wherein
the message comprising the source address is transmitted to an Access and Mobility Management Function, AMF (AMF), and
the message comprising the source address is a response message that is responsive to a request transmitted by the AMF.

11. The method of claim 1, wherein the request message for establishing the forwarding tunnel is a session establishment request or a session modification request.

12. The method of claim 1, wherein the handover related message is a Nsmf_PDUSession_UpdateSMContext request or Nsmf_PDUSession_CreateSMContext request.

13. The method of claim 1, wherein
the first network function is a 5G Session Management Function, SMF (SMF), and
the second network function is a 5G User Plane Function (UPF).

14-15. (canceled)

16. The method of claim 1, wherein the request message for establishing the forwarding tunnel indicates that a source address of the forwarding tunnel is required.

17. A method performed by a first network function, the method comprising:
receiving a handover related message related to a handover of a user equipment, UE, from a source radio access network, RAN, node to a target RAN node;
after receiving the handover related message, transmitting to a second network function a request message;
receiving a response message transmitted by the second network function, wherein the response message is responsive to the request message, and further wherein the response message comprises an address that a third network function will use as a source address when forwarding packets for the UE via a forwarding tunnel to the target RAN node; and
after receiving the response message, transmitting to the target RAN node a message comprising the source address.

18. The method of claim 17, wherein the handover related message is:
a Handover Required message, or
a request for creating a UE context.

19. The method of claim 17, wherein
the second network function is a Session Management Function, and
the request message transmitted to the second network function is a Nsmf_PDUSession_UpdateSMContext request or Nsmf_PDUSession_CreateSMContext request.

20. The method of claim 17, wherein the message transmitted to the target RAN node is a Handover Request.

21. The method of claim 17, wherein the message transmitted to the target RAN node is a Next Generation Application Protocol, NGAP, message.

22-29. (canceled)

30. A network function, the network function being configured to:
receive a handover related message related to a handover of a user equipment, UE, from a source radio access network, RAN, (RAN) node to a target RAN node;
after receiving the handover related message, transmit to a second network function a request message for establishing a forwarding tunnel;
receive a response message transmitted by the second network function, wherein the response message is responsive to the request message for establishing a forwarding tunnel, and further wherein the response message comprises an address that the second network function will use as a source address when forwarding packets for the UE via the established forwarding tunnel to the target RAN node; and
after receiving the response message, transmit a message comprising the source address, wherein the message is transmitted to: i) the target RAN node or ii) a third network function that is configured to transmit the source address to the target RAN node.

31. (canceled)

32. A network function, the network function being configured to:
receive a handover related message related to a handover of a user equipment, UE, from a source radio access network, RAN, node to a target RAN node;
after receiving the handover related message, transmit to a second network function a request message;
receive a response message transmitted by the second network function, wherein the response message is responsive to the request message, and further wherein the response message comprises an address that a third network function will use as a source address when forwarding packets for the UE via a forwarding tunnel to the target RAN node; and
after receiving the response message, transmit to the target RAN node a message comprising the source address.

33-34. (canceled)
